(19) United States
(12) Patent Application Publication
(10) Pub. No.: US 2023/0374314 A1
(43) Pub. Date: Nov. 23, 2023

(54) HIGH TRANSFER EFFICIENCY APPLICATION METHODS AND SHEAR THINNING COATING COMPOSITIONS FOR APPLICATION USING THE METHODS

(71) Applicant: PPG Industries Ohio, Inc., Cleveland, OH (US)

(72) Inventors: Jacob W. Mohin, Gibsonia, PA (US); Xinyu Lu, Pittsburgh, PA (US); Reza M. Rock, Pittsburgh, PA (US)

(73) Assignee: PPG Industries Ohio, Inc., Cleveland, OH (US)

(21) Appl. No.: 18/247,897

(22) PCT Filed: Oct. 4, 2021
(86) PCT No.: PCT/US2021/053290

§ 371 Date: Apr. 5, 2023

Related U.S. Application Data
(60) Provisional application No. 63/087,492, filed on Oct. 5, 2020.

(51) Int. Cl. C09D 5/02; C09D 175/04; C09D 7/20; C09D 7/43; C09D 133/00

(52) U.S. Cl. CPC C09D 5/024; C09D 175/04; C09D 7/20; C09D 7/43; C09D 133/00

(57) ABSTRACT

A method of forming a coating layer on at least a portion of a substrate that includes applying an aqueous coating composition to a substrate using a high transfer efficiency applicator. The aqueous coating composition includes (i) a film-forming polymer or resin, (ii) a polyurethane dispersion; (iii) crosslinked polymer microparticles; (iv) a polymer comprising one or more reactive functional groups; or (iv) combinations thereof. The aqueous coating composition has a viscosity ranging from 10 to 100 Pa*s at a shear stress of 1 Pa when measured using an Anton-Paar MCR301 rheometer equipped with a 50-millimeter parallel plate-plate fixture at 25° C. and a pressure of 101.3 kPa (1 atm) and keeping a plate-plate distance fixed at 0.2 mm.

### CROSS-REFERENCE TO RELATED APPLICATION

This application claims the benefit of priority of U.S. Provisional Application 63/087,492, filed Oct. 5, 2020, under 35 U.S.C. 119, titled “High Transfer Efficiency Application Methods and Shear Thinning Coating Compositions for Application Using the Methods”, which is incorporated herein by reference.

### FIELD

The present disclosure generally relates to methods for high transfer efficiency application of shear thinning coating compositions to a substrate. More particularly, it relates high transfer efficiency coating methods comprising forming a coating by applying to a substrate aqueous film-forming polymer or resin coating compositions, such as thermosetting or crosslinking compositions, that exhibit shear thinning in use conditions that expose the coating compositions to a shear rate from 10¹/s to 10⁶/s.

### BACKGROUND

Coating compositions may be applied to a wide variety of substrates using high transfer efficiency devices with little or no overspray, thereby eliminating the need for masking materials and multiple coating applications. Ink or valve jet printing of droplets and valve ejection of jets are examples of high transfer efficiency coating processes. However, in applying coating compositions with high transfer efficiency devices, suitable coating compositions would be limited to those that may successfully be applied from the devices to form a coating layer over the substrate. Thus, the advent of high transfer efficiency application devices spurs the desire to develop coating compositions which have improved performance in these applicators.

### SUMMARY

This disclosure is directed to a method of forming a coating layer on at least a portion of a substrate that includes applying an aqueous coating composition to a substrate using a high transfer efficiency applicator. The aqueous coating composition includes (i) a film-forming polymer or resin, (ii) a polyurethane dispersion; (iii) crosslinked polymer microparticles; (iv) a polymer comprising one or more reactive functional groups; or (iv) combinations thereof. he aqueous coating composition has a viscosity ranging from 10 to 100 Pa*s at a shear stress of 1 Pa when measured using an Anton-Paar MCR301 rheometer equipped with a 50-millimeter parallel plate-plate fixture at 25° C. and a pressure of 101.3 kPa (1 atm) and keeping a plate-plate distance fixed at 0.2 mm.

### DETAILED DESCRIPTION

Unless otherwise indicated, conditions of temperature and pressure are ambient temperature (22° C.), a relative humidity of 30%, and standard pressure of 101.3 kPa (1 atm).

Unless otherwise indicated, any term containing parentheses refers, alternatively, to the whole term as if parentheses were present and the term without them, and combinations of each alternative. Thus, as used herein the term, “(meth)acrylate” and like terms is intended to include acrylates, methacrylates and their mixtures.

It is to be understood that this disclosure may assume various alternative variations and step sequences, except where expressly specified to the contrary. Accordingly, unless indicated to the contrary, the numerical parameters set forth in the following specification and attached claims are approximations that can vary depending upon the desired properties to be obtained. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

All ranges are inclusive and combinable. For example, the term “a rheology modifier in an amount of up to 20 wt. % of the total solids of a coating composition, or from 0.01 to 10, alternatively from 0.05 to 5, or alternatively from 0.05 to 0.1, wt. %, based on the total weight of the coating composition” would include each of from 0.01 to 20 wt. %, from 0.01 to 10 wt. %, from 0.01 to 5 wt. %, from 0.01 to 0.1 wt. %, from 0.01 to 0.05 wt. %, from 0.05 to 0.1 wt. %, from 0.05 to 5 wt. %, from 0.05 to 10 wt. %, from 0.05 to 20 wt. %, from 0.1 to 20 wt. %, from 0.1 to 10 wt. %, from 0.1 to 5 wt. %, from 5 to 20 wt. %, from 5 to 10 wt. %, or from 10 to 20 wt. %. Further, when ranges are given, any endpoints of those ranges or numbers recited within those ranges can be combined within the scope of the present disclosure.

As used herein, unless otherwise expressly specified, all numbers such as those expressing values, ranges, amounts or percentages can be read as if prefaced by the word “about”, even if the term does not expressly appear. Unless otherwise stated, plural encompasses singular and vice versa. For example, while the disclosure has been described in terms of “a” swelling solvent or “a” hydrophobic polymer, a mixture of such swelling solvents of hydrophobic polymers can be used. As used herein, the term “including” and like terms means “including but not limited to”. Similarly, as used herein, the terms “on”, “applied on/over”, “formed on/over”, “deposited on/over”, “overlay” and “provided on/over” mean formed, overlay, deposited, or provided on but not necessarily in contact with the surface. For example, a coating layer “formed over” a substrate does not preclude the presence of one or more other coating layers of the same or different composition located between the formed coating layer and the substrate.

As used herein, the terms “a” and “an” shall be construed to include “at least one” and “one or more”.

As used herein, the transitional term “comprising” (and other comparable terms, e.g., “containing” and “including”) is “open-ended” and open to the inclusion of unspecified matter. Although described in terms of “comprising”, the terms “consisting essentially of” and “consisting of” are also within the scope of the disclosure.

High transfer efficiency coating enables precise application of one or more coatings to a substrate, such as a vehicle, and for minimizing overspray by generating drops of a uniform size that can be directed to a specific point on the substrate, thereby minimizing, or completely eliminating overspray. The demand for high transfer efficiency applications using coating compositions which have good appearance, knitting and anti-sagging properties in coatings and sedimentation resistant in the coating layer and on storage (for long shelf life) is increasing with increased user interest in high efficiency and mask-free coatings. However, current high transfer efficiency coating performance in use is not as good as those of conventional spray coatings. Low-shear viscosity performance in coating compositions improves their performance in high transfer efficiency applications comprising applying the coating compositions using a high transfer efficiency applicator. In accordance with the present disclosure, suitable aqueous coating compositions for use with high transfer efficiency applicators exhibit non-Newtonian fluid behavior which is in contrast to conventional ink. Further, the coating compositions when applied to the substrate using a high transfer efficiency applicator form a coating layer having precise boundaries, improved hiding, and reduced drying time compared to conventional ink. The coating compositions, when applied and cured, form a coating layer on the substrate. The coating composition may be one useful to form any of a basecoat, a clearcoat, a color coat, a top coat, a single-stage coat, a primer coat, a sealer coat, or combinations thereof, on a substrate or any cured or uncured coating layer. For example, the coating composition may form a basecoat coating layer.

Good control of low-shear viscosities at shear rate of 10-2 to 10/s, or at a low shear stress, has the effect of improving coating appearance, knitting, and decreasing sedimentation and sagging for vertical applications. Additionally, good control of higher-shear viscosities at shear rate of 102 to 106/s, or at a high shear stress, has the effect of improving defect free ejection of the coating composition and avoiding problems such as fouling or blocking of nozzles and entrapment of air bubbles.

The coating compositions described herein are useful in high transfer efficiency application methods of applying the coating composition to a substrate. The disclosed aqueous coating composition can have, on application, a low yield stress and good control of low-shear viscosities at a shear rate of from 10¹ to 10⁶ s⁻¹ to enable improved coating appearance, including smoothness and desired gloss, anti-sagging for vertical applications, knitting and sedimentation.

The present disclosure provides methods of applying aqueous coating compositions that exhibit shear thinning behavior and which exhibit a yield stress in application, and methods from applying them using high transfer efficiency applicators that may comprise one or more nozzles or valves containing a nozzle orifice that expel the aqueous coating composition and exert thereon a yield stress. The high transfer efficiency applicator, for example, contains a nozzle orifice that expels the coating composition as a droplet or jet and that exerts on the droplets or jets a yield stress, as a nonlimiting example from 1 to 10 Pa, as they are expelled from the nozzle orifice. The yield stress exerted on the aqueous coating composition may be greater than the shear force or strain needed to cause the viscosity of an aqueous coating composition to drop. The aqueous coating compositions of the present disclosure may be a pigmented basecoat coating composition. The droplets or jets expelled from the total number of orifices during the forming of a coating layer may have a uniform droplet or jet distribution.

The present disclosure provides methods of applying aqueous coating compositions that comprise one or more of a film-forming polymer or resin, an aqueous carrier, and further comprise a rheology modifier, one or more swelling solvents that will swell the film-forming polymer or resin, or combinations thereof. The coating compositions exhibit a defined rheology profile suitable for applying a coating composition using a high transfer efficiency applicator having a nozzle or valve containing a nozzle orifice, such as a printer, a print head or a valve jet applicator. The high transfer efficiency application methods of the present disclosure comprise forming a coating layer by applying one or more of the coating compositions of the present disclosure by use of a high transfer efficiency applicator having a nozzle or valve. The methods enable improved coating appearance, including smoothness and desired gloss, anti-sagging for vertical applications, as well as knitting and resistance to sedimentation in the coating layer.

The aqueous coating compositions in the methods of the present disclosure may exhibit a rheology profile defined as the ratio of the ambient viscosity at a shear stress of 1 Pa to the ambient viscosity at a shear stress of 10 Pa of 25:1 or higher, or, 50:1 or higher, or, 70:1 or higher, such as up to 350:1, up to 300:1, up to 250:1, up to 125:1, or up to 100:1, or, for example, from 25:1 to 350:1. Further, the aqueous coating compositions, have an ambient viscosity ranging from 7 to 100 Pa*s, such as 10 to 100 Pa*s at a shear stress of 1 Pa, have an ambient viscosity ranging from 0.03 to 1 Pa*s, such as 0.1 to 1 Pa*s at a shear stress of 10 Pa, and have a rheology profile defined as the ratio of the ambient viscosity at a shear stress of 1 Pa to the ambient viscosity at a shear stress of 10 Pa of 25:1 or higher, or, 50:1 or higher, or, 70:1 or higher, or higher, such as up to 350:1, up to 300:1, up to 250:1, up to 125:1, or up to 100:1, or, for example, from 25:1 to 350:1. With higher ambient viscosity at a shear stress of 10 Pa, the sagging effect of the coating composition can be diminished and the precision effect of high transfer efficiency applications can be improved.

As used herein, the term “aqueous” refers to a carrier or solvent comprising water and up to 50 wt. % of one or more water miscible organic solvents, such as alkyl ethers.

As used herein, the term “ASTM” refers to publications of ASTM International, West Conshohocken, PA.

As used herein, the term “basecoat” refers to a coating layer that provides protection, color, hiding (also known as “opacity”) and visual appearance. The term “basecoat coating composition” refers to a coating composition that contains colorants and that can be used to form a basecoat.

As used herein, the term “coating” refers to the finished product resulting from applying one or more coating compositions to a substrate and forming the coating, such as by curing. A primer layer, basecoat or color coat layer and clear coat layer may comprise part of a coating. As used herein, the term “coating layer” is used to refer to the result of applying one or more coating compositions on a substrate in one or more applications of such one or more coating compositions. For example, a single coating layer, referred to as a “color coat” or “top coat” can be used to provide the function of both a basecoat and a clearcoat and can comprise the result of two or more applications of a color coat coating composition.

As used herein, the term “crosslinking-functional group” refers to functional groups that are positioned in the backbone of the polymer, in a group pendant from the backbone of the polymer, terminally positioned on the backbone of the polymer, or combinations thereof, wherein such functional groups are capable of reacting with other crosslinking-functional groups or separate crosslinking materials during curing to produce a crosslinked coating.

As used herein, the term “film-forming” materials refers to film-forming constituents of a coating composition and can include polymers, resins, crosslinking materials or any combination thereof that are film-forming constituents of the coating composition. Film-forming materials may be cured by baking to heat or in ambient conditions.

As used herein, the term “hydrophilic group” refers to a moiety that has an affinity for water or capable of interacting with water as a nonlimiting example interacting through hydrogen bonding.

As used herein, the term “hydrophobic group” refers to a hydrocarbon or (alkyl)aromatic group, or an alkyl group have 4 or more carbon atoms. And, as used herein, the term “hydrophobic group containing alcohols” and “hydrophobic group containing ketones” means that that alcohol or ketone contains an (alkyl)aromatic group, or an alkyl group have 4 or more carbon atoms.

Unless otherwise indicated, as used herein, the term “molecular weight” refers to a weight average molecular weight as determined by gel permeation chromatography (GPC) using appropriate polystyrene standards. If a number average molecular weight is specified, the weight is determined in the same GPC manner, while calculating a number average from the thus obtained polymer molecular weight distribution data.

As used herein, the term “nozzle” refers to an opening through which a coating composition is ejected or jetted and, unless otherwise indicated, the term “nozzle” is used interchangeably with any of a valve jet, or piezo-electric, thermal, acoustic, or ultrasonic actuated valve jet or nozzle.

As used herein, the term “Ostwald ripening” refers to a phenomenon in which smaller particles in solution dissolve and deposit on larger particles in order to reach a more thermodynamically stable state wherein the surface to area ratio is minimized.

As used herein, the term “phr” means per hundred parts of resin solids, including all polymers or resins, or crosslinking materials.

As used herein, the term “polymer” includes homopolymers and copolymers that are formed from two or more different monomer reactants or that comprise two or more distinct repeat units. Further, the term “polymer” includes prepolymers, and oligomers and is defined in accordance with the Compendium of Polymer Terminology and Nomenclature: IUPAC Recommendations, 2008, Royal Society of Chemistry (ISBN 978 0 85404 491 7).

As used herein, the term “The Smith-Ewart process” refers to a mechanism of free-radical emulsion polymerization that includes a monomer being dispersed or emulsified in a solution of surfactant and water, forming relatively large droplets in the water; excess surfactant creates micelles in the water; small amounts of monomer diffuse through the water to the micelle; and a water-soluble initiator is introduced into the water phase where it reacts with monomer in the micelles.

As used herein, the term “substrate” refers to an article surface to be coated and can refer to a coating layer disposed on an article that is also considered a substrate.

As used herein, the term “target area” means a portion of the surface area of any substrate that is to be coated in applying any one coating composition, such as a first, a second or a third coating composition. The target area generally will not include the entire surface area of a given substrate. The term “non-target area” means the remainder of the surface area of the substrate. In applying multiple coating compositions, for each application of one coating composition, the target area and non-target areas may differ.

As used herein, the term “stable dispersion” of polymer microparticles in an aqueous medium refers to a dispersion that does not gel, flocculate, or precipitate at a temperature of 25° C. for at least 60 days, or, if some precipitation does occur, the precipitate can be readily redispersed upon agitation.

As used herein, “substantially free of water-soluble polymer” means that the aqueous medium contains no more than 30 wt. % of dissolved polymer, or no more than 15 wt. %.

As used herein, the term “swelling solvent” refers to a solvent that interacts with the film-forming resin causing it to swell and expand. The swelling solvent used with the coating compositions of the present disclosure can be an organic solvent. The swelling solvent used in accordance with the present disclosure can cause the low shear viscosity of the film-forming resin dispersion to increase by at least 20%, or, at least 50%, or at least 100%, or, at least 500% when added to the film-forming resin dispersion at 10 weight % based on resin solids.

As used herein, the term “thermosetting or crosslinking” means that a polymer or resin has functional groups that react with a crosslinking material or another polymer or molecule in any of use, application or cure.

As used herein, the term “total solids” or “solids” or “solids content” refers to the solids content as determined in accordance with ASTM D2369 (2015).

As used herein, the term “use conditions” means all temperatures and pressures, including ambient pressures, such as 101.3 kPa (1 atm), and temperatures at which any coating composition is used, stored, or applied, and may include temperatures as low as −10° C. and as high as 70° C.

As used herein, the term “uniform droplet or jet distribution” means that 60% or, 70%, or, 80% or more of the droplets or jets by volume have a size within 40%, or, 30%, or, 25%, or, 20% or less of the median size, as a nonlimiting example from 20% to 80%, from 25% to 70% or from 30% to 60% as determined using a light microscope. As used herein, a nominal median size for a droplet or jet is the diameter of each nozzle orifice(s) of the high transfer efficiency applicator.

As used herein, the term “vehicle” is used in its broadest sense and includes all types of vehicles, such as but not limited to cars, mini vans, SUVs (sports utility vehicle), trucks, semi-trucks; tractors, buses, vans, golf carts, motorcycles, bicycles, railroad cars, trailers, ATVs (all-terrain vehicle); pickup trucks; heavy duty movers, such as, bulldozers, mobile cranes and earth movers; aircraft; boats; ships; and other modes of transport. The ordinary skilled artisan will appreciate that the portion of the vehicle that is coated in accordance with the present disclosure may vary depending on the use or application of the coating. For example, anti-chip primers may be applied to some of the portions of the vehicle as described above. When used as a colored basecoat or monocoat, the present coatings will typically be applied to those portions of the vehicle that are visible such as the roof, hood, doors trunk lid and the like, but may also be applied to other areas such as inside the trunk, inside the door and the like. clearcoats will typically be applied to the exterior of a vehicle.

As used herein, unless otherwise stated, the term “viscosity” of a given coating composition is the value as determined at 25° C. and ambient pressure by measuring viscosity as a function of shear stress with an Anton-Paar MCR301 rheometer using a 50-millimeter parallel plate-plate fixture with temperature-control. The plate-plate distance was kept at a fixed distance of 0.2 mm and the temperature was a constant 25° C. The viscosity of coating compositions was measured over a stress range from 50 mPa to at least 500 Pa with a point spacing of 7 points per decade.

As used herein, the term “volume average particle size” refers to the ×50 median diameter of a particle distribution, as determined by dynamic light scattering using a Malvern Zetasizer Nano ZS.

As used herein, the phrase “wt. %” stands for weight percent.

As used herein, the phrase “yield stress” refers to the point at which the rate of decrease in the viscosity, as determined by measuring viscosity as a function of shear stress as defined herein at 25° C. and ambient pressure, of a coating composition in response to strain caused by shear, is highest. Yield stress is calculated by determining the stress at which the first derivative of the Log₁₀ of the viscosity versus shear stress reaches a minimum.

The aqueous coating compositions of the present disclosure have a viscosity (25° C./101.3 kPa (1 atm) pressure) measured as a function of shear stress caused over a stress range from 0.05 Pa to 500 Pa that ranges from 7 to 100 Pa*s, such as 10 to 100 Pa*s at a shear stress of 1 Pa and ranging from 0.03 to 1 Pa*s, such as 0.1 to 1 Pa*s at a shear stress of 10 Pa. When rheology profile is defined as the ratio of the viscosity at a shear stress of 1 Pa to the ambient viscosity at a shear stress of 10 Pa, the aqueous coating compositions of the present disclosure exhibit a rheology profile that ranges of from 25:1 to 150:1, for example, from 25:1 to 140:1, or, from 25:1 to 125:1, from 50:1 to 140:1, or, from 50:1 to 125:1, or, from 70:1 to 100:1. The recited viscosity in accordance with the methods of the present disclosure was determined at 25° C. and ambient pressure using an Anton-Paar MCR301 rheometer equipped with a 50-millimeter parallel plate-plate fixture with temperature-control and keeping a plate-plate distance fixed at 0.2 mm, and varying the shear stress with a point spacing of 7 points per decade.

The aqueous coating compositions in accordance with the methods and compositions of the present disclosure may exhibit a yield stress of from 1 to 10 Pa, or from 1 to 5.8 Pa. Yield stress, defined as the point at which the rate of decrease in the viscosity of the aqueous coating composition determined at 25° C. and 1 atm pressure is highest, is calculated by determining the stress at which the first derivative of the Log₁₀ of the viscosity versus shear stress reaches a minimum Further, the coating compositions exhibit a minimum first derivative of the Log₁₀ of the viscosity versus shear stress ranging from −0.1 to −5.0 mPa*s/mPa, or, from −0.3 to −5.0 mPa*s/mPa, or, from −1.1 to −5.0 mPa*s/mPa, or, from −0.3 to −1.0 mPa*s/mPa.

The methods of the present disclosure may comprise applying a primer or basecoat coating layer on a coated, primed or uncoated substrate prior to applying an aqueous basecoat coating composition using a high transfer efficiency applicator to form a precisely applied basecoat coating layer. The methods may also comprise forming a precisely applied clearcoat coating layer by applying an aqueous clearcoat coating layer or primer coating layer using a high transfer efficiency applicator. The substrate may be a vehicle or a portion thereof. The methods may further include providing a substrate, such as a substrate that is not masked with a removable material.

In accordance with the methods of the present disclosure, the high transfer efficiency applicator may comprise a valve jet applicator having one or more nozzle orifices, each of which ejects the coating composition in the form of a coherent coating composition jet. In the valve jet applicator of the present disclosure, each nozzle orifice may eject the coating composition to form a jet having the form of a line segment, an essentially planar jet or lamina, a hollow cylindrical jet, or wherein more than one nozzle orifices cooperatively expel the coating composition to form a liquid sheet.

In accordance with the methods of applying the aqueous coating compositions of the present disclosure, the carrier can be aqueous and can be exclusively water. However, it can be desirable to include a minor amount of up to 200 phr of inert organic solvent or the amount of solvent that would result in a coating composition having up to 200 g/L of total volatile organic content. Examples of suitable solvents which can be incorporated in the organic content are swelling solvents that swell or expand the polymer or resin particles or their compositions in use conditions, such as 25° C. and a pressure of 101.3 kPa (1 atm), such as alkyl ethers, for example, C4 or higher alkyl hydrophobic group containing ethers, glycol ethers, like monomethyl or monoethyl ethers of ethylene glycol or diethylene glycol, or for example, C4 or higher alkyl hydrophobic glycol ethers, like butyl glycol ethers, such as, for example, monobutyl ether of ethylene glycol, monobutyl ethers of diethylene glycol, hydrophobic group containing ketones, like methyl isobutyl ketone and diisobutyl ketone; hydrophobic group containing alcohols, like ethyl hexanol, alkyl esters, such as, for example, acetates like butyl acetate, ethyl acetate, n-butyl acetate, isobutyl acetate, and a combination thereof or other ketones, such as, for example, methyl ethyl ketone, methyl isobutyl ketone, methyl amyl ketone. Swelling solvents can provide extensional viscosity and rheology modifying effects in coatings when used in total in amounts of up to 200 wt. %, such as 0.05 wt. % or more, or, 0.2 wt. % or more, or, 1 wt. % or more, or, 2 wt. % or more, or, 5 wt. % or more, or, 10 wt. % or more, or, 120 wt. % or less, or, 60 wt. % or less, or, 30 wt. % or less, or, 20 wt. % or less, or, from 0.05 to 200 wt. %, or, for example, from 1 to 120 wt. %, or from 5 to 60 wt. %, or, from 10 to 30 wt. %, or from 0.05 to 20 wt. %, or from 0.2 to 8 wt. %, based on the weight of the total film-forming polymer or resin solids in the coating composition.

In accordance with the methods of the present disclosure, the aqueous coating compositions may comprise one or more rheology modifier. Suitable rheology modifiers may comprises an inorganic thixotropic agent such as silicon dioxide, a layered silicate, or clay; an associative thickener, such as a hydrophobically modified ethylene oxide urethane block copolymer (HEUR), hydrophobically-modified, alkali swellable emulsions (HASE) and hydrophobically-modified hydroxy ethyl cellulose (HMHEC), alkali-swellable emulsions (ASE); cellulosic thickeners such as carboxy methyl cellulose, methyl cellulose, hydroxyethyl cellulose and nano-crystalline cellulose; other organic thickeners such as polyvinyl alcohol, polyvinyl pyrrolidone, polyvinyl methylether, polyethylene oxide, polyacrylamide, ethylene vinyl acetate, polyamides, polyacrylic acid, mixtures thereof, or combinations thereof. The coating composition may include the rheology modifier in an amount that ranges up to 30 wt. %, or, from 1 to 30 wt. %, or, up to 20 wt. %, or, from 0.05 to 20 wt. %, or, from 1 to 30 wt. %, or, from 0.01 to 10 wt. %, or, from 0.05 to 5 wt. %, or, from 0.05 to 0.1 wt. %, based on the total polymer or resin solids of the coating composition.

In accordance with the methods and compositions of the present disclosure, a coating composition may comprise a polymer having crosslinked polymer microparticle or polyurethane dispersion having at least one crosslinking-functional group and dissolved at least partially in the swelling solvent, a crosslinking material of a melamine resin, and a HEUR associative thickener.

The aqueous coating compositions in accordance with the present disclosure and the methods of the present disclosure comprise an aqueous carrier and a film-forming polymer or resin and can include (i) a polyurethane dispersion; (ii) crosslinked polymer microparticles; (iii) a polymer comprising one or more reactive functional groups; (iv) any combination of any two or more of (i) to (iii). The aqueous coating compositions may comprise from 0.5 to 20 wt. % or from 2 to 8 wt. %, based on the total weight of the coating composition of organic solvent or swelling solvent, or an amount of solvent that would result in a coating composition having up to 200 g/L of total coating composition volume.

In accordance with the methods and compositions of the present disclosure, the coating composition may comprise a film-forming polymer or resin that has at least one crosslinking-functional group, and the coating composition further comprises a crosslinking material having at least one functional group reactive with the crosslinking-functional group. Suitable crosslinking materials, such as melamine and other crosslinking materials can be present in the amount of up to 30 wt. %, or, for example, from 1 to 30 wt. %, or, from 1 to 20 wt. %, or, from 1 to 10 wt. %, based on the total film-forming polymer or resin solids of the coating composition.

The aqueous coating compositions of the present disclosure may include a polyurethane dispersion, such as an aqueous polyurethane dispersion. Suitable aqueous polyurethane dispersions include polyurethane-acrylate particles dispersed in an aqueous medium. The dispersed polyurethane-acrylate particles include the reaction product obtained by polymerizing the reactants of a pre-emulsion formed from an active hydrogen-containing polyurethane acrylate prepolymer that includes a reaction product obtained by reacting (A) (i) a polyol; (ii) a polymerizable ethylenically unsaturated monomer containing at least one hydroxyl group; (iii) a compound comprising a C₁ to C30 alkyl group having at least two active hydrogen groups selected from carboxylic acid groups and hydroxyl groups, wherein at least one active hydrogen group is a hydroxyl group; and (iv) a polyisocyanate. The polyurethane acrylate prepolymer may further comprise the reaction product obtained by reacting (A) with (B) a hydrophobic polymerizable ethylenically unsaturated monomer; and (C), optionally, a crosslinking monomer. The active hydrogen-containing polyurethane acrylate prepolymer (A) in the polyurethane-acrylate particles of the present disclosure may be accounted for in an amount of at least 20 wt. %, or, at least 25 wt. %, or, at least 30 wt. %, or, at least 35 wt. % and or, at least 40 wt. % of the solids of the polyurethane-acrylate particles. Further, the active hydrogen-containing polyurethane acrylate prepolymer (A) may be present in an amount of up to 80 wt. %, or, up to 75 wt. %, or, up to 70 wt. %, or, up to 65 wt. %, or, up to 60 wt. % of the solids of the polyurethane-acrylate particles.

The hydrophobic polymerizable ethylenically unsaturated monomers (B) in the polyurethane-acrylate particles of the present disclosure may be accounted for in an amount of at least 20 wt. %, or, at least 25 wt. %, or, at least 30 wt. %, or, at least 35 wt. %, or, at least 40 wt. % of the total solids of the polyurethane-acrylate particles. Further, the hydrophobic polymerizable ethylenically unsaturated monomers (B) may be present in an amount of up to 80 wt. %, or, up to 75 wt. %, or, up to 70 wt. %, or, up to 65 wt. %, or, up to 60 wt. % of the total solids of the polyurethane-acrylate particles.

The crosslinking monomer (C) in the polyurethane-acrylate particles of the present disclosure may be accounted for in an amount of at least 1 wt. %, or, at least 2 wt. %, or, at least 3 wt. %, or, at least 4 wt. %, or, at least 5 wt. % of the solids of the polyurethane-acrylate particles. Further, the crosslinking monomer (C) may be present in an amount of up to 20 wt. %, or, up to 17.5 wt. %, or, up to 15 wt. %, or, up to 12.5 wt. %, or, up to 10 wt. % of the total solids of the polyurethane-acrylate particles.

The polyurethane acrylate particles of the present disclosure may include the reaction product of other reactants, such as a carboxylic acid group containing monomer. So, the value of (A)+(B)+(C) may be 100%, but will be less than 100% when other materials known to the skilled artisan are included in the polyurethane-acrylate particles.

The polyol (i) may be one or more polyols selected from polyetherpolyols, polyesterpolyols and acrylic polyols. A suitable polyol may be one or more polyetherpolyols described by the structure below:

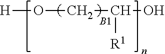

wherein each R¹ independently is H or C₁ to C₅ alkyl, n is from 1 to 200 and m is from 1 to 5. Examples of suitable polyetherpolyols that may be used include, but are not limited to, poly(oxytetramethylene) glycols; poly(oxyethylene) glycols; poly(oxy-1,2-propylene) glycols; 1,6-hexanediol; poly(tetrahydrofuran); trimethylolpropane; sorbitol; pentaerythritol; the reaction products of ethylene glycol with a mixture of 1,2-propylene oxide and ethylene oxide; the reaction products obtained by the polymerization of ethylene oxide, propylene oxide and tetrahydrofuran and mixtures of polyols can be used as polyol (i).

Suitable polymerizable ethylenically unsaturated monomers containing at least one hydroxyl group (ii) may be one or more monomers having the following structure:

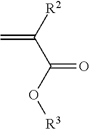

wherein R² is H or C₁ to C₄ alkyl and R³ is selected from —(CHR₄)p-OH—CH₂CH₂—(O—CH₂—CHR⁴)p-OH, —CH₂—CHOH— CH₂—O—CO—CR⁵R⁶R⁷, and —CH₂—CHR⁴—O— CH₂—CHOH— CH₂—O—CO—CR⁵R⁶R⁷ where R⁴ is H or C₁ to C₄ alkyl, R⁵, R⁶, and R⁷ independently are H or C₁ to C₂₀ linear or branched alkyl, and p is an integer from 0 to 20. Examples of suitable polymerizable ethylenically unsaturated monomers containing at least one hydroxyl group (ii) include, but are not limited to, hydroxyethyl(meth)acrylate, hydroxypropyl(meth)acrylate, hydroxybutyl(meth)acrylate, polyethyleneglycol ester of (meth)acrylic acid, polypropyleneglycol ester of (meth)acrylic acid, the reaction product of (meth)acrylic acid and the glycidyl ester of versatic acid, the reaction product of hydroxyethyl(meth)acrylate and the glycidyl ester of versatic acid, and the reaction product of hydroxypropyl(meth)acrylate and the glycidyl ester of versatic acid. One nonlimiting example is CARDURA™ Resin E-10 glycidyl ester of versatic acid (Resolution Performance Products, Houston, TX). Mixtures of such hydroxyl group-containing monomers can be used. Nonlimiting suitable examples of the compound (iii) may include dimethylol propionic acid and/or 12-hydroxy stearic acid.

The polyisocyanate (iv) may be an aliphatic and/or an aromatic polyisocyanate. Examples of polyisocyanates that may be used as polyisocyanate (iv) include, but are not limited to, isophorone diisocyanate, 4,4′-diphenylmethane diisocyanate, 1,3-phenylene diisocyanate, 1,4-phenylene diisocyanate, tolylene diisocyanate, 1,4-tetramethylene diisocyanate, 1,6-hexamethylene diisocyanate, 1,4-cyclohexyl diisocyanate, alpha, alpha-xylylene diisocyanate, 4,4′-methylene-bis(cyclohexyl isocyanate), 1,2,4-benzene triisocyanate, and polymethylene polyphenyl isocyanate. Mixtures of such polyisocyanates also can be used.

The hydrophobic polymerizable ethylenically unsaturated monomers (B) in the polyurethane-acrylate particles of the present disclosure may be any suitable hydrophobic polymerizable ethylenically unsaturated monomers. As used herein, the term “hydrophobic monomer” refers to a monomer that is “substantially insoluble” in water. As used herein, the term “substantially insoluble in water” means that a monomer has a solubility in distilled water of less than 6 g/100 g at 25° C. as determined by placing 3 g of water and 0.18 g of monomer in a test tube at 25° C. and shaking the test tube. On visual examination, if two distinct layers form, the monomer is considered to be hydrophobic. If a cloudy solution forms, the turbidity of the mixture is measured using a turbidimeter or nephelometer (for example, Hach Model 2100AN, Hach Company, Loveland, CO). A reading of greater than 10 nephelometric turbidity units (NTU) indicates that the monomer is considered to be hydrophobic. Examples of suitable hydrophobic monomers include, but are not limited to, methyl(meth)acrylate, ethyl(meth)acrylate, propyl(meth)acrylate, N-butyl(meth)acrylate, t-butyl(meth)acrylate, 2-ethylhexyl(meth)acrylate, isobornyl (meth)acrylate, glycidyl (meth)acrylate, N-butoxy methyl (meth)acrylamide, styrene, (meth)acrylonitrile, lauryl (meth)acrylate, cyclohexyl (meth)acrylate, and 3,3,5-trimethylcyclohexyl (meth)acrylate. Mixtures of such hydrophobic monomers also can be used.

The crosslinking monomer (C) of the polyurethane-acrylate particles of the present disclosure may have two or more sites of polymerizable ethylenic unsaturation. Any suitable crosslinking monomer may be used to prepare the polyurethane-acrylate particles of the present aqueous polyurethane dispersion. For example, suitable crosslinking monomers include, but are not limited to, ethylene glycol di(meth)acrylate, triethylene glycol di(meth)acrylate, tetraethylene glycol di(meth)acrylate, 1,3-butylene glycol di(meth)acrylate, trimethylolpropane tri(meth)acrylate, 1,4-butanediol di(meth)acrylate, neopentyl glycol di(meth)acrylate, 1,6-hexanediol di(meth)acrylate, pentaerythritol di(meth)acrylate, pentaerythritol tri(meth)acrylate, pentaerythritol tetra(meth)acrylate, glycerol di(meth)acrylate, glycerol allyloxy di(meth)acrylate, 1,1,1-tris(hydroxymethyl)ethane di(meth)acrylate, 1,1,1-tris(hydroxymethyl)ethane tri(meth)acrylate, 1,1,1-tris(hydroxymethyl)propane di(meth)acrylate, 1,1,1-tris(hydroxymethyl)propane tri(meth)acrylate, triallyl cyanurate, triallyl isocyanurate, triallyl trimellitate, diallyl phthalate, diallyl terephthalate, divinyl benzene, methylol (meth)acrylamide, triallylamine, and methylenebis (meth) acrylamide. Mixtures of such crosslinking monomers also can be used.

In aqueous dispersions, the polyurethane-acrylate particles may form an ordered macroscopic structure that occurs, in part, because of the compositional balance and resulting hydrophobic-hydrophilic balance as well as the molecular weight of the active hydrogen-containing polyurethane acrylate prepolymer. These two balances are controlled by the relative molar ratios of the polyol (i); the polymerizable ethylenically unsaturated monomer containing at least one hydroxyl group (ii); the compound having at least two active hydrogen groups (iii); and the polyisocyanate (iv) in the active hydrogen-containing polyurethane acrylate prepolymer.

The incorporation of the various reactants into the active hydrogen-containing polyurethane acrylate prepolymer can occur in a statistically predictable manner. In preparing the present active hydrogen-containing polyurethane acrylate prepolymer, an excess of hydroxyl functionality from compounds (i), (ii) and (iii) can be present relative to isocyanate functionality from the polyisocyanate of (iv). This results in the formation of polymer molecules having end groups having hydroxyl functionality from (i) or (iii), and/or an end group containing a polymerizable ethylenically unsaturated group from (ii). The distribution and amount of the carboxylic group of the compound of (iii) on the resulting polyurethane acrylate prepolymer determines the hydrophobic-hydrophilic balance of the prepolymer.

A statistical distribution of three distinct prepolymer molecules can result from the preparation of the polyurethane acrylate prepolymer. One prepolymer that can be formed is a first surfactant-like prepolymer, which has a hydroxyl and/or carboxylic functional group at one end of the prepolymer and a polymerizable ethylenically unsaturated group at the opposite end of the prepolymer. Additionally, a second surfactant-like prepolymer can result, which has a hydroxyl and/or carboxylic functional group at both ends of the prepolymer. Another prepolymer that can result is a hydrophobic prepolymer that does not contain any carboxylic acid groups, and which has polymerizable ethylenically unsaturated groups at both ends of the prepolymer molecule. The first and second surfactant-like prepolymers and the hydrophobic prepolymer may each provide distinct structural features to the polyurethane-acrylate particles of the present aqueous polyurethane dispersion. For the purposes of the present disclosure, the polyurethane-acrylate particle reaction product (A) is considered to be a mixture of the aforementioned three distinct prepolymers, as well as any unreacted portions of materials (i), (ii), (iii) and (iv), and any reaction by-products.

During the preparation of the aqueous polyurethane dispersion, the hydrophobic polymerizable ethylenically unsaturated monomers (B) and the crosslinking monomer (C) may be added to the active hydrogen-containing polyurethane acrylate prepolymer (A) and passed through a high shear fluid processor for deagglomeration and dispersion of uniform submicron particles, resulting in a stable emulsion or dispersion. Suitable processors include but are not limited to MICROFLUIDIZER™ (Microfluidics™ division of MFIC Corporation, Newton, MA). The submicron particles that are formed contain, in polymerized form, the monomers (B) and (C) and the various prepolymers (A), described above.

In accordance with the polyurethane-acrylate particles of the present disclosure, the hydrophobic prepolymer may associate with the monomers (B) and (C), acting like a sponge to hold the monomers and preventing leakage of the monomers from the submicron particles. The first surfactant-like prepolymer and the second surfactant-like-prepolymer orient with the sponge structure formed by the hydrophobic prepolymer, such that the ends of the prepolymer molecules having hydroxyl and/or carboxylic acid functional groups orient toward the aqueous continuous phase of the dispersion. This orientation of the first and second surfactant-like prepolymers may provide electrostatic stabilization to the dispersed particles and help to prevent agglomeration and/or flocculation of the dispersed particles. The association behavior may minimize the need for conventional stabilizing surfactants. The ability to provide a stable polyurethane dispersion without the inclusion of anionic surfactants allows for improved humidity resistance, adhesion and less yellowing when the thermosetting composition is used as a basecoat coating composition, especially in multi-layer coating applications, and, particularly, when the top coat or clear coat coating layer comprises a layer formed at least in part from a powder coating composition.

In accordance with the polyurethane-acrylate particles of the present disclosure, monomer polymerization can be conducted using a suitable free radical initiator, as defined below. Not being bound to any particular theory, it is believed that on polymerization, the location and orientation of the various prepolymer species and the monomers (B) and (C) are “locked into place.” In this way it is believed that the ordered macroscopic structure of the polyurethane-acrylate particles is derived from the compositional ratios and resulting hydrophobic-hydrophilic balance of the various prepolymer species.

Accordingly, the acid-functional polyurethane acrylate prepolymer (A) may include at least 30 wt. %, or, at least 35 wt. %, or, at least 40 wt. %, or, at least 45 wt. % or, at least 50 wt. % of the first surfactant-like prepolymer. When the first surfactant-like prepolymer content is too low, the dispersed particles may not be sufficiently stabilized to prevent agglomeration or flocculation. The acid-functional polyurethane acrylate prepolymer (A) may include up to 80 wt. %, or, up to 75 wt. %, or, up to 70 wt. %, or, up to 65 wt. % or, up to 60 wt. % of the first surfactant-like prepolymer. When the first surfactant-like prepolymer content is too high, there may not be enough hydrophobic prepolymer present to prevent monomer leakage from the particles as in Oswald ripening.

The acid-functional polyurethane acrylate prepolymer (A) may include at least 1 wt. %, or at least 5 wt. %, or at least 10 wt. %, or at least 15 wt. % or at least 20 wt. %, of the second surfactant-like prepolymer. When the second surfactant-like prepolymer content is too low, the dispersed particles may not be sufficiently stabilized to prevent agglomeration or flocculation. The acid-functional polyurethane acrylate prepolymer (A) may include up to 40 wt. %, or up to 37 wt. %, or, up to 35 wt. %, or, up to 33 wt. % or, up to 30 wt. % of the second surfactant-like prepolymer. When the first surfactant-like prepolymer content is too high, there may not be enough hydrophobic prepolymer present to prevent monomer leakage and Oswald ripening.

The acid-functional polyurethane acrylate prepolymer (A) may include at least 10 wt. %, or, at least 12.5 wt. %, or, at least 15 wt. %, or, at least 17.5 wt. % and or, at least 20 wt. % of the hydrophobic prepolymer as described above. When the hydrophobic prepolymer content is too low, it may be that monomer leakage and/or Oswald ripening may not be adequately prevented. The acid-functional polyurethane acrylate prepolymer (A) may include up to 50 wt. %, or, up to 45 wt. %, or, up to 40 wt. %, or, up to 37.5 wt. % or, up to 35 wt. % of the hydrophobic prepolymer. When the hydrophobic prepolymer content is too high, it may be that it becomes difficult to stabilize the dispersed particles.

The average molecular weight of the active hydrogen-containing polyurethane acrylate prepolymer of the present disclosure can be measured by gel permeation chromatography (GPC) using polystyrene standards. However, because of the structural and chemical differences between the active hydrogen-containing polyurethane acrylate prepolymer and the polystyrene standard used to calibrate the GPC instrument, the values for the molecular weight of the active hydrogen-containing polyurethane acrylate prepolymer is an estimate. When the GPC methods described above are used to determine the weight average molecular weight of the active hydrogen-containing polyurethane acrylate prepolymer, the molecular weight can be at least 2,000, or, at least 2,100, or, at least 2,200, or, at least 2,250 and or, at least 2,500. When the molecular weight is too low, the hydrophobic prepolymer species may not be able to prevent monomer migration and/or Oswald ripening. The molecular weight, as measured by GPC of the active hydrogen-containing polyurethane acrylate prepolymer may be up to 10,000, or, up to 9,000, or, up to 7,500, or, up to 6,000 and or, up to 5,000. When the molecular weight is too high, the surfactant species of the active hydrogen-containing polyurethane acrylate prepolymer may not be able to adequately stabilize the dispersed particles. The molecular weight of the active hydrogen-containing polyurethane acrylate prepolymer may be any value or range between any of the recited values, inclusive of those stated above.

In accordance with the present disclosure, the ordered macroscopic structure of the polyurethane-acrylate dispersed particles comprises an outer portion and an interior portion. The outer portion comprises greater than 50 wt. % of the dispersed particle near the aqueous medium and includes residues from the first surfactant prepolymer. The interior portion of the dispersed particle includes the hydrophobic prepolymer and greater than 50 wt. % of the reaction product of the one or more hydrophobic polymerizable ethylenically unsaturated monomers (B); and crosslinking monomer (C).

The weight average particle size of the polyurethane-acrylate particles of the present aqueous polyurethane dispersion may be at least 50 nanometers, or, at least 60 nanometers, or, at least 75 nanometers, or, at least 100 nanometers and or, at least 150 nanometers. When the particle size is too small, the surface area of the particles may be so large that there will not be enough surfactant-like prepolymer to prevent agglomeration or flocculation of the particles. The average particle size of the polyurethane-acrylate particles of the present aqueous polyurethane dispersion may be up to one micron, or, up to 500 nanometers, or, up to 400 nanometers, or, up to 300 nanometers and or, up to 250 nanometers. When the particle size is too large, it may become difficult to prevent settling of the particles. The particle size of the polyurethane-acrylate particles may be determined by dynamic light scattering using a Malvern Zetasizer Nano ZS or, alternatively measured with a Coulter counter (Beckman Coulter, Brea, CA), following the manufacturer's detailed instructions.

The coating compositions in accordance with the present disclosure may comprise crosslinked polymeric microparticles as a film-forming polymer or resin. When uncrosslinked the polymer(s) within the microparticle can be either linear or branched. he polymeric microparticle may or may not be internally crosslinked. When the microparticles are internally crosslinked, they are referred to as a microgel.

The crosslinked polymeric microparticles in accordance with the present disclosure may be prepared from a monomer mix that includes: (a) a crosslinking monomer having two or more sites of reactive unsaturation and/or monomers having one or more functional groups capable of reacting to form crosslinks after polymerization, such as one or more crosslinking-functional groups; (b) a polymerizable ethylenically unsaturated monomer having hydrophilic functional groups having the following structures (I) and/or (II):

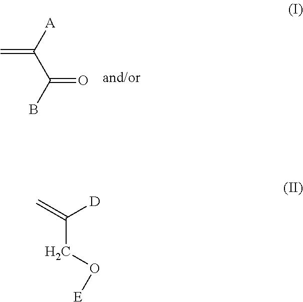

wherein A is selected from H and C₁ to C₃ alkyl; B is selected from —NR¹R², —OR³ and —SR⁴, where R¹ and R² are independently selected from H, C₁ to C₁₈ alkyl, C₁ to C₁₈ alkylol and C₁ to C₁₈ alkylamino, R³ and R⁴ are independently selected from C₁ to C₁₈ alkylol, C₁ to C₁₈ alkylamino, —CH₂CH₂—(OCH₂CH₂)n-OH where n is 0 to 30, and —CH₂CH₂—(OC(CH₃)HCH₂)m-OH where m is 0 to 30, D is selected from H and C₁ to C₃ alkyl; and E is selected from —CH₂CHOHCH₂OH, C₁ to C₁₈ alkylol, —CH₂CH₂—(OCH₂CH₂)n-OH where n is 0 to 30, and —CH₂CH₂—(OC(CH₃)HCH₂)m-OH where m is 0 to 30; and, optionally, (c) one or more polymerizable ethylenically unsaturated monomers, where (a), (b) and (c) are different from each other. As used herein, the term “alkylol” means a hydrocarbon radical that contains one or more hydroxyl groups; and the term “alkylamino” means a hydrocarbon radical that contains one or more amine groups. As used herein, when referring to an aqueous emulsion that includes crosslinked polymeric microparticles dispersed in an aqueous continuous phase, a “suitable” material can be a material that may be used in or in preparing the aqueous emulsion, so long as the material does not substantially affect the stability of the aqueous emulsion or the polymerization process.

Crosslinking monomers suitable for use as the crosslinking monomer (a) in forming crosslinked polymer microparticles in accordance with the present disclosure can include any monomer having two or more sites of reactive unsaturation, or any monomer that has one or more functional groups capable of reacting to form crosslinks after polymerization. As used herein, functional groups that are capable of reacting to form crosslinks after polymerization refer to functional groups on a first polymer molecule that may react to form covalent bonds with functional groups on a second polymer molecule to form a crosslinked polymer. Functional groups that may react to form crosslinks include, but are not limited to N-alkoxymethyl amides, N-methylolamides, lactones, lactams, mercaptans, hydroxyls, epoxides and the like. Examples of such monomers include, but are not limited to, N-alkoxymethyl(meth)acrylamides, gamma-(meth)acryloxytrialkoxysilane, N-methylol(meth)acrylamide, N-butoxymethyl(meth)acrylamide, (meth)acrylic lactones, N-substituted (meth)acrylamide lactones, (meth)acrylic lactams, and N-substituted (meth)acrylamide lactams and glycidyl (meth)acrylate.

A suitable crosslinking monomer (a) in accordance with the crosslinked polymeric microparticles of the present disclosure can have two sites of reactive unsaturation. Suitable crosslinking monomers may be one or more of ethylene glycol di(meth)acrylate, triethylene glycol di(meth)acrylate, tetraethylene glycol di(meth)acrylate, 1,3-butylene glycol di(meth)acrylate, trimethylolpropane tri(meth)acrylate, 1,4-butanediol di(meth)acrylate, neopentyl glycol di(meth)acrylate, 1,6-hexanediol di(meth)acrylate, pentaerythritol di(meth)acrylate, pentaerythritol tri(meth)acrylate, pentaerythritol tetra(meth)acrylate, glycerol di(meth)acrylate, glycerol allyloxy di(meth)acrylate, 1,1,1-tris(hydroxymethyl)ethane di(meth)acrylate, 1,1,1-tris(hydroxymethyl)ethane tri(meth)acrylate, 1,1,1-tris(hydroxymethyl)propane di(meth)acrylate, 1,1,1-tris(hydroxymethyl)propane tri(meth)acrylate, triallyl cyanurate, triallyl isocyanurate, triallyl trimellitate, diallyl phthalate, diallyl terephthalate, divinyl benzene, methylol (meth)acrylamide, triallylamine, and methylenebis (meth) acrylamide.

The crosslinking monomer (a) comprises at least 15 wt. %, typically at least 20 wt. %, or, at least 22.5 wt. %, and or, at least 25 wt. % of the monomer mix used to prepare the polymeric microparticles. Also, the crosslinking monomer comprises not more than 45 wt. %, or, not more than 40 wt. %, or, not more than 35 wt. %, or, not more than 30 wt. % of the monomer mix used to prepare the polymeric microparticles. The level of the crosslinking monomer (a) used is determined by the desired properties, such as swellability, incorporated into the resulting microparticle.

Any of the polymerizable ethylenically unsaturated monomers having hydrophilic functional groups of structures I and/or II, above, may be used as the monomer (b) provided that the monomer can be polymerized in an emulsion polymerization system and does not substantially affect the stability of the emulsion polymer or the polymerization process.

Polymerizable ethylenically unsaturated monomers having hydrophilic functional groups suitable for use as the monomer (b) in the preparation of the polymeric microparticles of the present disclosure include, but are not limited to (meth)acrylamide, hydroxyethyl(meth)acrylate, hydroxypropyl(meth)acrylate, dimethylaminoethyl (meth)acrylate, allyl glycerol ether, methallyl glycerol ether and polyethyleneoxide allyl ether.

In accordance with the crosslinked polymer microparticles of the present disclosure, a particular advantage of the present crosslinked polymeric microparticles is that they do not require the presence of an alkaline material to swell the microparticles, thereby providing desired rheological properties. This eliminates the additional processing step of adding an alkaline material to promote particle swelling and renders the resulting rheological properties more predictable.

In accordance with the crosslinked polymer microparticles of the present disclosure, the polymerizable ethylenically unsaturated monomers having hydrophilic functional groups (b) include only monomers having the structure (I), above, and not the monomers of structure (II), above.

Alternatively, in accordance with the crosslinked polymer microparticles of the present disclosure, the polymerizable ethylenically unsaturated monomers having hydrophilic functional groups (b) include only monomers having the structure (II), above, and not the monomers of structure (I), above.

In accordance with the crosslinked polymer microparticles of the present disclosure, the polymerizable ethylenically unsaturated monomer having hydrophilic functional groups (b) comprises at least 2 wt. %, or, greater than 2 wt. %, or, at least 5 wt. %, or, greater than 5 wt. %, or, at least 7 wt. %, or, at least 8 wt. % of the monomer mix used to prepare the polymeric microparticles. The polymerizable ethylenically unsaturated monomer having hydrophilic functional groups comprises not more than 35 wt. %, or, not more than 30 wt. %, or, more than 20 wt. %, or, not more than 15 wt. % of the monomer mix used to prepare the polymeric microparticles. The level of the polymerizable ethylenically unsaturated monomer having hydrophilic functional groups used is determined by the properties that are to be incorporated into the resulting microparticle. The level of the polymerizable ethylenically unsaturated monomer having hydrophilic functional groups present in the monomer mix can range between any combination of the recited values inclusive of the recited values.

In accordance with the crosslinked polymeric microparticles of the present disclosure, polymerizable ethylenically unsaturated monomers suitable for use as the monomer (c) which, optionally, make up the remainder of the monomer mix, and which are different from the crosslinking monomer (a) and the monomer having hydrophilic functional groups (b), may be included in the polymeric microparticles of the present disclosure. Any suitable polymerizable ethylenically unsaturated monomer may be used, provided that it is capable of being polymerized in an aqueous emulsion polymerization system and does not substantially affect the stability of the emulsion or the polymerization process. Suitable polymerizable ethylenically unsaturated monomers include, but are not limited to, methyl(meth)acrylate, ethyl(meth)acrylate, propyl(meth)acrylate, N-butyl(meth)acrylate, t-butyl(meth)acrylate, 2-ethylhexyl(meth)acrylate, isobornyl (meth)acrylate, dimethylaminoethyl (meth)acrylate, styrene, (meth)acrylonitrile, lauryl (meth)acrylate, cyclohexyl (meth)acrylate, and 3,3,5-trimethylcyclohexyl (meth)acrylate.

In accordance with the crosslinked polymer microparticles of the present disclosure, the polymerizable ethylenically unsaturated monomer (c) may comprise at least 20 wt. %, typically at least 30 wt. %, in many cases at least 40 wt. %, and or, at least 50 wt. % of the monomer mix used to prepare the polymeric microparticles. The polymerizable ethylenically unsaturated monomers may comprise not more than 80 wt. %, in many cases not more than 75 wt. %, typically not more than 70.5 wt. %, and or, not more than 67 wt. % of the monomer mix used to prepare the polymeric microparticles. The level of the polymerizable ethylenically unsaturated monomer (c) which can be used is determined by the properties that are to be incorporated into the resulting microparticle. The level of the polymerizable ethylenically unsaturated monomer (c) present in the monomer mix may range between any combination of the recited values inclusive of the recited values.

In accordance with the crosslinked polymeric microparticles of the present disclosure, the crosslinking monomer (a) may comprise one or more of glycol di(meth)acrylates and glycol tri(meth)acrylates; the polymerizable ethylenically unsaturated monomer having hydrophilic functional groups (b) comprises (meth)acrylamide; and the polymerizable ethylenically unsaturated monomer (c) comprises one or more alkyl(meth)acrylates.

The aqueous emulsion of crosslinked polymeric microparticles of the present disclosure may be prepared by aqueous emulsion polymerization of (a), (b) and optionally, (c), as described above. In many cases, the monomer mixture of (a), (b) and (c) will readily disperse into stable monomer droplets and micelles as would be expected in a Smith-Ewart process. In such cases, no monomeric or polymeric emulsifiers and/or protective colloids are added to the aqueous emulsion, and the aqueous emulsion is substantially free of polymeric emulsifiers and/or protective colloids. It should be understood, however, that, a surface-active agent may be added to the aqueous continuous phase to stabilize, or prevent coagulation or agglomeration of the monomer droplets, especially during polymerization.

The surface-active agent can be present in the aqueous emulsion of the present disclosure at any level that stabilizes the emulsion. The surface-active agent may be present at least 0.001 wt. %, or, at least 0.005 wt. %, or, at least 0.01 wt. %, and or, at least 0.05 wt. %, based on the total weight of the aqueous emulsion. The surface-active agent may be present at up to 10 wt. %, or, to 7.5 wt. %, or, up to 5 wt. %, and or, up to 3 wt. %, based on the total weight of the aqueous emulsion. The level of the surface-active agent used is determined by the amount required to stabilize the aqueous emulsion. The surface active agent may be present in the aqueous emulsion at any level or in any range of levels inclusive of those stated above.

The surface-active agent may be an anionic, cationic, or nonionic surfactant or dispersing agent, or compatible mixtures thereof, such as a mixture of an anionic and a nonionic surfactant. Suitable cationic dispersion agents include, but are not limited to lauryl pyridinium chloride, cetyldimethyl amine acetate, and alkyldimethylbenzylammonium chloride, in which the alkyl group has from 8 to 18 carbon atoms. Suitable anionic dispersing agents include, but are not limited to alkali fatty alcohol sulfates, such as sodium lauryl sulfate, and the like; arylalkyl sulfonates, such as potassium isopropylbenzene sulfonate, and the like; alkali alkyl sulfosuccinates, such as sodium octyl sulfosuccinate, and the like; and alkali arylalkylpolyethoxyethanol sulfates or sulfonates, such as sodium octylphenoxypolyethoxyethyl sulfate, having 1 to 5 oxyethylene units, and the like. Suitable non-ionic surface active agents include but are not limited to alkyl phenoxypolyethoxy ethanols having alkyl groups of from 7 to 18 carbon atoms and from 6 to 60 oxyethylene units such as, for example, heptyl phenoxypolyethoxyethanols; ethylene oxide derivatives of long chained carboxylic acids such as lauric acid, myristic acid, palmitic acid, oleic acid, and the like, or mixtures of acids such as those found in tall oil containing from 6 to 60 oxyethylene units; ethylene oxide condensates of long chained, C8 or more, alcohols such as octyl, decyl, lauryl, or cetyl alcohols containing from 6 to 60 oxyethylene units; ethylene oxide condensates of long-chain or branched chain amines such as dodecyl amine, hexadecyl amine, and octadecyl amine, containing from 6 to 60 oxyethylene units; and block copolymers of ethylene oxide sections combined with one or more hydrophobic propylene oxide sections. High molecular weight polymers such as hydroxyethyl cellulose, methyl cellulose, polyacrylic acid, polyvinyl alcohol, and the like, may be used as emulsion stabilizers and protective colloids.

A free radical initiator may be used in the aqueous emulsion polymerization process. Any suitable free radical initiator may be used. Suitable free radical initiators include, but are not limited to thermal initiators, photoinitiators and oxidation-reduction initiators, all of which may be otherwise categorized as being water-soluble initiators or non-water-soluble initiators. Examples of thermal initiators include, but are not limited to azo compounds, peroxides and persulfates. Suitable persulfates include but are not limited to sodium persulfate and ammonium persulfate. Oxidation-reduction initiators may include as non-limiting examples persulfate-sulfite systems as well as systems utilizing thermal initiators in combination with less than 5000 ppm of metal ions, like iron or copper based on the weight emulsion polymerization composition.

Suitable azo compounds include, but are not limited to non-water-soluble azo compounds such as 1-1′-azobis(cyclohexanecarbonitrile), 2-2′-azobis(isobutyronitrile), 2-2′-azobis(2-methylbutyronitrile), 2-2′-azobis(propionitrile), 2-2′-azobis(2,4-dimethylvaleronitrile), 2-2′-azobis(valeronitrile), 2-(carbamoylazo)-isobutyronitrile and mixtures thereof; and water-soluble azo compounds such as azobis tertiary alkyl compounds include, but are not limited to, 4-4′-azobis(4-cyanovaleric acid), 2-2′-azobis(2-methylpropionamidine) dihydrochloride, 2,2′-azobis[2-methyl-N-(2-hydroxyethyl)propionamide], 4,4′-azobis(4-cyanopentanoic acid), 2,2′-azobis(N,N′-dimethyleneisobutyramidine), 2,2′-azobis(2-amidinopropane) dihydrochloride, 2,2′-azobis(N,N′-dimethyleneisobutyramidine) dihydrochloride and mixtures thereof.

Suitable peroxides include, but are not limited to hydrogen peroxide, methyl ethyl ketone peroxides, benzoyl peroxides, di-t-butyl peroxides, di-t-amyl peroxides, dicumyl peroxyesters, dialkyl peroxides, hydroperoxides, peroxyketals and mixtures thereof.

In accordance with the present disclosure, the weight average particle size of the crosslinked polymer microparticles may be at least 0.001 μm, or, at least 0.005 μm, or, at least 0.01 μm, or, at least 0.02 μm. The weight average particle size of the polymeric microparticles may be 1 micron or less, or, not more than 0.9 μm, or, not more than 0.8 μm. When the average particle size is too large, the microparticles may tend to settle from the aqueous emulsion upon storage. The average particle size of the polymeric microparticles may be determined by dynamic light scattering or measured with a Coulter counter (Beckman Coulter, Brea, CA), following the manufacturer's detailed instructions.

In accordance with the present disclosure, the aqueous dispersion of crosslinked polymeric microparticles in an aqueous continuous phase may be prepared by a seeded aqueous emulsion polymerization process. Such a seeded aqueous emulsion polymerization process may include: (I) providing an overall monomer composition that includes: (a) at least 20 wt. % of the overall monomer composition including a crosslinking monomer, such as any of those described above; (b) at least 2 wt. % of the overall monomer composition of a polymerizable ethylenically unsaturated monomer having hydrophilic functional groups such as any of those having the structures (I) or (II) described, above; and, (c) the balance of the overall monomer composition including one or more polymerizable ethylenically unsaturated monomers, such as any of those described in detail, above, with respect to the polymerizable ethylenically unsaturated monomer (c) useful in forming the crosslinked polymeric microparticles, where (a), (b) and (c) are different from each other; (II) polymerizing a portion of the overall monomer mix, the portion including from 0.1 to 20 wt. % of (a) and from 0.1 to 20 wt. % of (c) to form polymeric seeds dispersed in the continuous phase; and, (Ill) polymerizing the remainder of monomers (a), (b) and (c) in the presence of the dispersed polymeric seeds prepared in step (II) to form an aqueous emulsion of seeded polymeric microparticles.

The resulting aqueous emulsion of seeded polymeric microparticles may have improved stability as compared to unseeded polymeric microparticles. As used herein, the term “improved stability” means improved resistance to settling of the microparticles. In the seeded emulsion polymerization, the polymerizable, ethylenically unsaturated monomers having hydrophilic functional groups may be incorporated primarily on the surface of the microparticles. This structure may add considerable electrostatic and/or steric repulsion to the microparticles, thereby avoiding agglomeration and/or settling of the resulting microparticles. Further, the polymerizable ethylenically unsaturated monomer having hydrophilic functional groups are more likely to agglomerate and form micelles at the hydrophobic seeds formed from a portion of (a) and a portion of (c). Hence, the ethylenically unsaturated monomer(s) having hydrophilic functional groups are less likely to polymerize in the continuous phase forming undesirable grit, coagulum or gel.

In the composition of the present disclosure, the polymers comprising one or more reactive functional groups can include any reactive functional groups. For example, the functional groups can comprise one or more of epoxy, carboxylic acid, hydroxy, amide, oxazoline, aceto acetate, isocyanate, methylol, amino, methylol ether, and carbamate. Likewise, the functional groups of any curing agent in the composition of the present disclosure can include any reactive functional groups, provided such groups are reactive with one or more reactive functional groups of the polymer. For example, the functional groups of the curing agent can comprise one or more of epoxy, carboxylic acid, hydroxy, isocyanate, capped isocyanate, amine, methylol, methylol ether, and beta-hydroxyalkylamide. Generally, the functional groups of the polymer comprising one or more reactive functional groups and any crosslinking material will be different from and reactive with each other. The polymers comprising one or more reactive functional groups of the present disclosure can comprise functional groups that are reactive with a crosslinking material present in a different coating composition that is applied to a substrate either before or after composition of the present disclosure. The crosslinking material may then react with the polymer comprising one or more reactive functional groups after migrating into the claimed composition.

Examples of suitable polymers comprising one or more reactive functional groups for use in the coating compositions of the present disclosure include, but are not limited to, film-forming polymers with at least one reactive functional group. Such polymers can include any of a variety of functional polymers known in the art. For example, suitable hydroxyl group-containing polymers can include acrylic polymers, acrylic polyols, polyester polyols, polyurethane polyols, polyether polyols, and mixtures thereof. In the present disclosure, the film-forming polymer may comprise an acrylic polyol having a hydroxyl equivalent weight ranging from 1000 to 100 grams per solid equivalent, or, for example, from 500 to 150 grams per solid equivalent.

Suitable hydroxyl group and/or carboxyl group-containing acrylic polymers comprising one or more reactive functional groups can be prepared from polymerizable ethylenically unsaturated monomers and are typically copolymers of (meth)acrylic acid and/or hydroxylalkyl esters of (meth)acrylic acid with one or more other polymerizable ethylenically unsaturated monomers such as alkyl esters of (meth)acrylic acid including methyl (meth)acrylate, ethyl (meth)acrylate, butyl (meth)acrylate and 2-ethyl hexylacrylate, and vinyl aromatic compounds such as styrene, alpha-methyl styrene, and vinyl toluene.

In accordance with the present disclosure the acrylic polymers comprising one or more reactive functional groups can be prepared from ethylenically unsaturated, beta-hydroxy ester functional monomers. Such monomers can be derived from the reaction of an ethylenically unsaturated acid functional monomer, such as monocarboxylic acids, for example, acrylic acid; and an epoxy compound which does not participate in the free radical initiated polymerization with the unsaturated acid monomer. Examples of such epoxy compounds include glycidyl ethers and esters. Suitable glycidyl ethers include glycidyl ethers of alcohols and phenols such as butyl glycidyl ether, octyl glycidyl ether, phenyl glycidyl ether and the like. Suitable glycidyl esters include those which are commercially available from Shell Chemical Company under the tradename CARDURA E; and from Exxon Chemical Company under the tradename GLYDEXX-10. Alternatively, the beta-hydroxy ester functional monomers can be prepared from an ethylenically unsaturated, epoxy functional monomer, for example glycidyl (meth)acrylate and allyl glycidyl ether, and a saturated carboxylic acid, such as a saturated monocarboxylic acid, for example isostearic acid.

Epoxy functional groups can be incorporated into a polymer comprising one or more reactive functional groups prepared from polymerizable ethylenically unsaturated monomers by copolymerizing oxirane group-containing monomers, for example glycidyl (meth)acrylate and allyl glycidyl ether, with other polymerizable ethylenically unsaturated monomers, such as those discussed above. Nonlimiting examples of preparation of such epoxy functional acrylic polymers is described in detail in U.S. Pat. No. 4,001,156 to Bosso and Wismer at columns 3 to 6.

Carbamate functional groups can be incorporated into a polymer comprising one or more reactive functional groups when prepared from polymerizable ethylenically unsaturated monomers by copolymerizing, for example, the above-described ethylenically unsaturated monomers with a carbamate functional vinyl monomer such as a carbamate functional alkyl ester of methacrylic acid. Useful carbamate functional alkyl esters can be prepared by reacting, for example, a hydroxyalkyl carbamate, such as the reaction product of ammonia and ethylene carbonate or propylene carbonate, with methacrylic anhydride. Other useful carbamate functional vinyl monomers include, for instance, the reaction product of hydroxyethyl methacrylate, isophorone diisocyanate, and hydroxypropyl carbamate; or the reaction product of hydroxypropyl methacrylate, isophorone diisocyanate, and methanol. Still other carbamate functional vinyl monomers may be used, such as the reaction product of isocyanic acid (HNCO) with a hydroxyl functional acrylic or methacrylic monomer such as hydroxyethyl acrylate, and those described in U.S. Pat. No. 3,479,328 to Nordstrom. Carbamate functional groups can also be incorporated into the acrylic polymer by reacting a hydroxyl functional acrylic polymer with a low molecular weight alkyl carbamate such as methyl carbamate. Pendant carbamate groups can also be incorporated into the acrylic polymer by a “transcarbamoylation” reaction in which a hydroxyl functional acrylic polymer is reacted with a low molecular weight carbamate derived from an alcohol or a glycol ether. The carbamate groups exchange with the hydroxyl groups yielding the carbamate functional acrylic polymer and the original alcohol or glycol ether. Also, hydroxyl functional acrylic polymers can be reacted with isocyanic acid to provide pendent carbamate groups. Likewise, hydroxyl functional acrylic polymers can be reacted with urea to provide pendent carbamate groups.

Suitable acrylic polymers comprising one or more reactive functional groups may be prepared from polymerizable ethylenically unsaturated monomers, can be prepared by solution polymerization techniques, which are well-known to those skilled in the art, in the presence of suitable catalysts such as organic peroxides or azo compounds, as described above. The polymerization can be carried out in an organic solution in which the monomers are soluble by techniques conventional in the art. Alternatively, these polymers can be prepared by aqueous emulsion or dispersion polymerization techniques which are well-known in the art. The ratio of monomer reactants and reaction conditions are selected to result in an acrylic polymer with the desired pendent functionality.

The coating compositions of the present disclosure may suitably comprise polyester polymers as iii) polymers comprising one or more reactive functional groups or as film formers in aqueous compositions that further comprise polyester film-forming polymers. Useful polyester polymers typically include the condensation products of polyhydric alcohols and polycarboxylic acids. Suitable polyhydric alcohols can include ethylene glycol, neopentyl glycol, trimethylol propane, and pentaerythritol. Suitable polycarboxylic acids can include adipic acid, 1,4-cyclohexyl dicarboxylic acid, and hexahydrophthalic acid. Besides the polycarboxylic acids mentioned above, functional equivalents of the acids such as anhydrides where they exist or lower alkyl esters of the acids such as the methyl esters can be used. Also, small amounts of monocarboxylic acids such as stearic acid can be used. The ratio of reactants and reaction conditions are selected to result in a polyester polymer with the desired pendent functionality, i.e., carboxyl or hydroxyl functionality. For example, hydroxyl group-containing polyesters can be prepared by reacting an anhydride of a dicarboxylic acid such as hexahydrophthalic anhydride with a diol such as neopentyl glycol in a 1:2 molar ratio. Where it is desired to enhance air-drying, suitable drying oil fatty acids may be used and include those derived from linseed oil, soybean oil, tall oil, dehydrated castor oil, or tung oil.

Carbamate functional polyesters suitable as polymers comprising one or more reactive functional groups can be prepared by first forming a hydroxyalkyl carbamate that can be reacted with the polyacids and polyols used in forming the polyester. Alternatively, terminal carbamate functional groups can be incorporated into the polyester by reacting isocyanic acid with a hydroxy functional polyester. Also, carbamate functionality can be incorporated into the polyester by reacting a hydroxyl polyester with a urea. Additionally, carbamate groups can be incorporated into the polyester by a transcarbamoylation reaction. Preparation of suitable carbamate functional group-containing polyesters are those described in U.S. Pat. No. 5,593,733 to Mayo at column 2, line 40 to column 4, line 9.

Polyurethane polymers containing terminal isocyanate or hydroxyl groups also can be used as polymers comprising one or more reactive functional groups in the aqueous coating compositions of the disclosure. The polyurethane polyols or NCO-terminated polyurethanes which can be used are those prepared by reacting polyols including polymeric polyols with polyisocyanates. Polyureas containing terminal isocyanate or primary and/or secondary amine groups which also can be used are those prepared by reacting polyamines including polymeric polyamines with polyisocyanates. The hydroxyl/isocyanate or amine/isocyanate equivalent ratio can be adjusted and reaction conditions are selected to obtain the desired terminal groups. Examples of suitable polyisocyanates include those described in U.S. Pat. No. 4,046,729 to Scriven et al. at column 5, line 26 to column 6, line 28. Examples of suitable polyols include those described in U.S. Pat. No. 4,046,729 at column 7, line 52 to column 10, line 35. Examples of suitable polyamines include those described in U.S. Pat. No. 4,046,729 at column 6, line 61 to column 7, line 32 and in U.S. Pat. No. 3,799,854 to Jerabek at column 3, lines 13 to 50.

Carbamate functional groups can be introduced into the polyurethane polymers by reacting a polyisocyanate with a polyester having hydroxyl functionality and containing pendent carbamate groups. Alternatively, the polyurethane can be prepared by reacting a polyisocyanate with a polyester polyol and a hydroxyalkyl carbamate or isocyanic acid as separate reactants. Examples of suitable polyisocyanates are aromatic isocyanates, such as 4,4′-diphenylmethane diisocyanate, 1,3-phenylene diisocyanate and toluene diisocyanate, and aliphatic polyisocyanates, such as 1,4-tetramethylene diisocyanate and 1,6-hexamethylene diisocyanate. Cycloaliphatic diisocyanates, such as 1,4-cyclohexyl diisocyanate and isophorone diisocyanate also can be employed.

Examples of suitable polyether polyols include polyalkylene ether polyols such as those having the following structural formulas (III) or (IV):

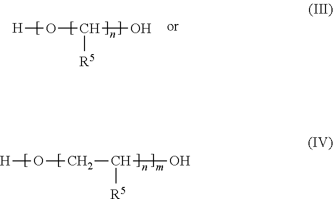

wherein the substituent R⁵ independently for each occurrence is hydrogen or a lower alkyl group containing from 1 to 5 carbon atoms including mixed substituents, and n has a value ranging from 2 to 6 and m has a value ranging from 8 to 150, or up to 100. Exemplary polyalkylene ether polyols include poly(oxytetramethylene) glycols, poly(oxytetraethylene) glycols, poly(oxy-1,2-propylene) glycols, and poly(oxy-1,2-butylene) glycols.

Also useful as polymers comprising one or more reactive functional groups are polyether polyols formed from oxyalkylation of various polyols, for example, glycols such as ethylene glycol, 1,6-hexanediol, Bisphenol A, or other higher polyols such as trimethylolpropane, pentaerythritol, and the like. Polyols of higher functionality which can be utilized as indicated can be made, for instance, by oxyalkylation of compounds such as sucrose or sorbitol. A nonlimiting example of a commonly utilized oxyalkylation method is reaction of a polyol with an alkylene oxide, for example, propylene or ethylene oxide, in the presence of an acidic or basic catalyst. Specific examples of polyethers include TERATHANE and TERACOL polyethers (E. I. DuPont de Nemours and Company, Inc., Wilmington, DE).

Generally, when a polymer comprises one or more reactive functional groups, the polymer will have a weight average molecular weight (Mw) ranging from 1,000 to 20,000, or from 1,500 to 15,000, or, from 2,000 to 12,000 as determined by gel permeation chromatography using polystyrene standards.

Polyepoxides such as those described below as crosslinking materials can also be used as the polymer comprising one or more reactive functional groups in accordance with the present disclosure.

Polymers comprising one or more reactive functional groups in accordance with the present disclosure find use in thermosetting coating compositions. The polymers may be present in a thermosetting coating composition of the present disclosure in an amount of at least 2 wt. %, or, at least 5 wt. %, or, at least 10 wt. %, based on weight of total resin solids in the coating composition. Also, the polymers comprising one or more reactive functional groups may be present in the thermosetting coating compositions of the disclosure in an amount of not more than 80 wt. %, or, not more than 60 wt. %, or, not more than 50 wt. %, based on weight of total resin solids in the thermosetting coating compositions.

In accordance with the present disclosure, the coating compositions may comprise thermosetting or crosslinking film-forming polymer or resin compositions adapted to be chemically bound into the coating when cured because they contain functional groups such as hydroxyl groups or carboxyl groups or amine groups which are capable of co-reacting, for example, with a crosslinking material such as melamine resins or, alternatively, with other film-forming resins or polymers which may be present in the coating composition. Thus, the coating composition can be thermosetting or crosslinking wherein the film-forming polymer or resin has at least one crosslinking-functional group. For example, the aqueous polyurethane dispersions, crosslinked polymer microparticles or polymers comprising one or more reactive functional groups as film-forming polymers or resins may have at least one crosslinking-functional group and comprise a thermosetting or crosslinking polymer composition. The composition may further comprise a crosslinking material. In accordance with the methods and compositions of the present disclosure, an amount of crosslinking material ranges up to 50 wt. %, or, up to 30 wt. %, or, 1 wt. % or more, or, 2 wt. % or more, or, for example, from 1 to 50 wt. %, from 1 to 30 wt. %, or, from 1 to 20 wt. % or from 1 to 10 wt. %, or from 2 to 20 wt. %, based on the total solids of the film-forming polymer or resin in the coating composition may improve the swelling performance of the coating composition or coatings made therefrom.

In accordance with the present disclosure, suitable thermosetting or crosslinking film-forming polymer or resin compositions may have one or more crosslinking-functional groups, such as carboxylic acid group, a hydroxyl group or an isocyanate-reactive group. Suitable crosslinking-functional groups can include hydroxyl, thiol, isocyanate, blocked isocyanate, thioisocyanate, acetoacetoxy, carboxyl, primary amine, secondary amine, amide, epoxy, anhydride, ketimine, aldimine, amides, carbamates, ureas, vinyl or a combination thereof. Other suitable functional groups such as orthoester, orthocarbonate, cyclic amide or cyclic imide, e.g., maleimide, that can generate hydroxyl or amine groups once the ring structure is opened are also suitable as crosslinking-functional groups. Crosslinking materials containing aromatic groups provide better corrosion resistance such as, for example, in epoxy resin film-forming polymer or resin compositions.

Suitable iii) polymers which have at least one crosslinking-functional group may have a number average molecular weight of 300 or more, or 500 or more, or 800 or more, for example, ranging from 500 to 100,000, more usually from 750 to 5000.

The amount of acid functionality in a carboxyl group containing thermosetting or crosslinking film-forming polymers comprising one or more reactive functional groups can be measured by acid value, the number of milligrams of KOH per gram of solid required to neutralize the acid functionality in the resin. The acid value of the hydrophobic polymer ranges from 5 to 100 mg KOH/g resin, or from 5 to 20 mg KOH/g resin, such as below 10, or, for example, below 5. Polymer having acid functionality can be water-dispersible if they contain other hydrophilic portions such as poly (ethylene oxide) groups or if they are chain extended, such as with dimethylol propionic acid or other suitable hydroxy carboxylic acids.

The amount of acid functionality in iii) a thermosetting or crosslinking carboxyl group containing polymer film-forming polymer or resin can be measured by acid value, the number of milligrams of KOH per gram of solid required to neutralize the acid functionality in the resin. The acid value of the polymer ranges from 5 to 100 mg KOH/g resin, or from 5 to 20 mg KOH/g resin, such as below 10, or, for example, below 5. Polymers having acid functionality comprising one or more reactive functional groups can be water-dispersible if they contain other hydrophilic portions such as poly (ethylene oxide) groups or if they are chain extended, such as with dimethylol propionic acid or other suitable hydroxy carboxylic acids. Acid functional thermosetting or crosslinking film-forming polymers containing acid values higher than 20 mg KOH/g resin can be used in combination with an amount of hydroxyl or epoxy functional crosslinking material, such as a hydroxyl functional polyester or polyurethane, or a polyether. Such compositions exhibit high viscosities in aqueous media and can form durable thermoset coatings upon crosslinking of the acid functional groups. Acid functional polymers comprising one or more reactive functional groups having acid values higher than 20 mg KOH/g resin can be used in combination with an amount of hydroxyl or epoxy functional crosslinking material, such as a hydroxyl functional polyester or polyurethane, or a polyether. Such compositions exhibit high viscosities in aqueous media and can form durable thermoset coatings upon crosslinking of the acid functional groups.

A suitable aqueous coating composition may comprise as a film-forming polymer or resin iii) a composition of a polyester polymer comprising one or more reactive functional groups; ii) an internally crosslinked polymer microparticle containing one or more hydroxyl groups and containing a polyurethane, a mixture of an internally crosslinked polymer microparticles containing hydroxyl groups and a polyurethane polymer, a mixture of iii) a polyurethane dispersion and iii) an aqueous emulsion polymer comprising one or more reactive functional groups, or combinations thereof; and a melamine resin crosslinking material.

In accordance with the coating compositions of the present disclosure, the amount of the film-forming polymer or resin can range from 10 to 90 wt. %, based on the total solids of the coating composition, or, for example, from 12 to 80 wt. %, or, from 20 to 70 wt. %, or from 50 to 70 wt. %.

The coating compositions of the present disclosure may also comprise one or more crosslinking materials adapted to cure the polymeric microparticles, aqueous emulsion polymers or hydrophobic polymers. Non-limiting examples of suitable crosslinking materials include aminoplasts, polyisocyanates, polyacids, polyanhydrides, polyamines, polyepoxides, such as those disclosed above, and mixtures thereof. The one or more crosslinking materials used depends upon the functionality associated with the polymer. For example, where the functionality of the polymer is hydroxyl, the crosslinking material can be an aminoplast or isocyanate.

Suitable aminoplast resin crosslinking materials contain the addition products of formaldehyde, with an amino- or amido-group carrying substance. Condensation products obtained from the reaction of alcohols and formaldehyde with melamine, urea or benzoguanamine are most commonly used herein. However, condensation products of other amines and amides can also be employed, for example, aldehyde condensates of triazines, diazines, triazoles, guanadines, guanamines and alkyl- and aryl-substituted derivatives of such compounds, including alkyl- and aryl-substituted ureas and alkyl- and aryl-substituted melamines. Some examples of such compounds are N-,N′-dimethyl urea, benzourea, dicyandiamide, formaguanamine, acetoguanamine, glycoluril, ammeline, 2-chloro-4,6-diamino-1,3,5-triazine, 6-methyl-2,4-diamino-1,3,5-triazine, 3,5-diaminotriazole, triaminopyrimidine, 2-mercapto-4,6-diaminopyrimidine, or 3,4,6-tris(ethylamino)-1,3,5 triazine. While the aldehyde employed can be formaldehyde, other similar condensation products can be made from other aldehydes, such as acetaldehyde, crotonaldehyde, acrolein, benzaldehyde, furfural, glyoxal and the like. The aminoplast resins can contain methylol or similar alkylol groups, and in most instances at least a portion of these alkylol groups is etherified by a reaction with an alcohol to provide organic solvent-soluble resins. Any monohydric alcohol can be employed for this purpose, including such alcohols as methanol, ethanol, propanol, butanol, pentanol, hexanol, heptanol and others, as well as benzyl alcohol and other aromatic alcohols, cyclic alcohols such as cyclohexanol, monoethers of glycols, and halogen-substituted or other substituted alcohols, such as 3-chloropropanol and butoxyethanol. Suitable aminoplast resins are substantially alkylated with methanol or butanol.

Suitable polyisocyanate crosslinking materials can be prepared from a variety of polyisocyanates and may be a blocked diisocyanate. Examples of suitable diisocyanates include toluene diisocyanate, 4,4′-methylene-bis (cyclohexyl isocyanate), isophorone diisocyanate, an isomeric mixture of 2,2,4- and 2,4,4-trimethyl hexamethylene diisocyanate, 1,6-hexamethylene diisocyanate, tetramethyl xylylene diisocyanate and 4,4′-diphenylmethylene diisocyanate. In addition, blocked polyisocyanate prepolymers of various polyols such as polyester polyols can also be used. Examples of suitable blocking agents include those materials which would unblock at elevated temperatures including lower aliphatic alcohols such as methanol, oximes such as methyl ethyl ketoxime and lactams such as caprolactam.

Polyacid crosslinking materials suitable for use in the present disclosure on average generally contain greater than one acid group per molecule, often three or more, such as four or more, such acid groups being reactive with epoxy functional film-forming polymers. Suitable polyacid crosslinking materials have di-, tri- or higher functionalities and may include carboxylic acid group-containing oligomers, polymers and compounds, such as acrylic polymers, polyesters, and polyurethanes and compounds having phosphorus-acid groups. Examples of suitable polyacid crosslinking materials include ester group-containing oligomers and compounds including half-esters formed from reacting polyols and cyclic 1,2-acid anhydrides or acid functional polyesters derived from polyols and polyacids or anhydrides. These half-esters are of relatively low molecular weight, as a nonlimiting example, less than 1000 g/mol, and are quite reactive with epoxy functionality. Suitable ester group containing oligomers are disclosed in U.S. Pat. No. 4,764,430 to Blackburn et al., at column 4, line 26 to column 5, line 68. Other useful polyacid crosslinking materials include acid-functional acrylic crosslinking materials made by copolymerizing methacrylic acid and/or acrylic acid monomers with other ethylenically unsaturated copolymerizable monomers as the polyacid crosslinking material. Alternatively, acid-functional acrylics can be prepared from hydroxy-functional acrylics reacted with cyclic anhydrides.

In accordance with the coating compositions of the present disclosure, suitable amounts of the crosslinking material may range from 1 to 50 wt. %, or from 1 to 30 wt. %, or from 2 to 30 wt. %, or from 5 to 40 wt. %, or from 20 to 30 wt. %, or from based on total polymer or resin solids.

In accordance with the coating compositions of the present disclosure, shear thinning dispersions of crosslinked polymer microparticles or polymers containing more than 5 wt. % of acrylic acid, or having an acid value greater than 40 can be combined with one or more adjuvant prepared by esterification of reactants comprising one or more monocarboxylic acids, such as fatty acids or C₄ to C₂₂ monocarboxylic acids and one or more polyols, such as glycols or triols in a 1:1 molar ratio, for example, in a stiochiometric amount of carboxyl to hydroxyl groups. Non-limiting examples of adjuvants prepared by the above esterification reaction include trimethylolpropane monoisostearate, di-trimethylolpropane isostearate, pentaerythritol isostearate and pentaerythritol diisostearate. The adjuvants and the polymers can be reacted together upon curing the coating composition after application.

In accordance with the present disclosure, coating compositions can contain rheology modifiers. Non-limiting examples of suitable rheology modifiers include, for example, thixotropic agents such as bentonite clay, urea-containing compounds, layered silicate solutions and gels in propylene glycol, acrylic alkali swellable emulsions (ASEs), associative thickeners, such as nonionic hydrophobically modified ethylene oxide urethane block copolymers (referred to herein as “HEUR”) or hydrophobically modified acrylic alkali swellable emulsions (HASEs), and combinations thereof. The coating composition may include the rheology modifier in an amount of up to 20 wt. % of the total solids of a coating composition, or from 0.01 to 10, alternatively from 0.05 to 5, or alternatively from 0.05 to 0.1 wt. %, based on the total weight of the coating composition. Suitable coating compositions may include a layered silicate propylene glycol solution, an ASE, or a combination thereof. The layered silicate propylene glycol solution includes a synthetic layered silicate, water, and polypropylene glycol. A nonlimiting example of a suitable synthetic layered silicate is LAPONITE™ RD, LAPONITE™ RDS, LAPONITE™ S482 and LAPONITE™ SL25 layered silicate compositions (Altana AG of Wesel, DE). A nonlimiting example of a suitable ASE is a VISCALEX™ HV 30 (BASF Corporation of Florham Park, NJ).

Suitable coating compositions may contain HEUR, which may be a linear and branched HEUR formed by reacting a polyglycol, a hydrophobic alcohol, a diisocyanate, and a triisocyanate together in a one-pot reaction as in US 2009/0318595A1 to Steinmetz et al.; or those formed by polymerizing in a solvent-free melt, in the presence of a catalyst, such as bismuth octoate, of a polyisocyanate branching agent, a water-soluble polyalkylene glycol having an M_{w} (GPC using peg standards) of from 2000 to 11,000 Daltons, and a diisocyanate as in U.S. Pat. No. 9,150,683B2 to Bobsein et al. The hydrophobic alcohol of Steinmetz may include, for example, alcohols having a carbon number ranging from 3 to 24, from 5 to 20, or from 10 to 25, such as octanol, dodecanol, tetradecanol, hexadecanol, cyclohexanol, phenol, cresol, octylphenol, nonyl phenol, dodecyl phenol, tristyrylphenol, ethoxylated tristyrylphenol, monomethyl ethers of ethylene glycol, monoethyl ethers of ethylene glycol, monobutyl ethers of ethylene glycol, monomethyl ethers of ethylene diethylene glycol, monoethyl ethers of diethylene glycol, monobutyl ethers of diethylene glycol; alkyl and alkaryl polyether alcohols such as straight or branched alkanol/ethylene oxide and alkyl phenol/ethylene oxide adducts, for example, the lauryl alcohol, t-octylphenol or nonylphenolethylene oxide adducts containing 1-250 ethylene oxide groups; and other alkyl, aryl and alkaryl hydroxyl compounds, or combinations thereof. The branching agent of Bobsein may include, for example, triisocyanates, such as 1,6,11-undecane triisocyanate; isocyanurates, such as isophorone diisocyanate isocyanurate; and biurets, such as tris(isocyanatohexyl)biuret; the hydrophobic capping agent of Bobsein may include, for example, at least one of n-octanol, n-nonanol, n-decanol, n-undecanol, n-dodecanol, 2-ethylhexanol, 2-butyl-1-octanol, or 3,7-dimethyl-1-octanol.

In accordance with the present disclosure, the coating composition can also include fillers or extenders, such as barytes, talc and clays in amounts up to 70 wt. %, based on total weight of the coating composition. Primer coating compositions may comprise extenders or fillers, including a supercritical amount wherein the coating layer comprises less than the amount of film-forming polymer or resin needed to encapsulate all pigments, fillers and extenders.

In accordance with the present disclosure, the coating compositions can further comprise one or more pigments and/or dyes as colorants. Suitable colorants can comprise any one or more suitable pigment or dye. Non-limiting examples of suitable pigments include titanium dioxide, zinc oxide, iron oxide, carbon black, mono azo red, red iron oxide, quinacridone maroon, transparent red oxide, cobalt blue, iron blue, iron oxide yellow, chrome titanate, titanium yellow, nickel titanate yellow, transparent yellow oxide, lead chromate yellow, bismuth vanadium yellow, pre darkened chrome yellow, transparent red oxide chip, iron oxide red, molybdate orange, molybdate orange red and combinations thereof. Non-limiting examples of suitable dyes include dioxazine carbazole violet, phthalocyanine blue, indanthrone blue, mono azo permanent orange, ferrite yellow, diarylide yellow, indolinone yellow, monoazo yellow, benzimidazolone yellow, isoindoline yellow, tetrachloroisoindoline yellow, disazo yellow, anthanthrone orange, quinacridone orange, benzimidazolone orange, phthalocyanine green, quinacridone red, azoic red, diketopyrrolopyrrole red, perylene red, scarlet or maroon, quinacridone violet, thioindigo red, and combinations thereof. The coating compositions may comprise pigments in amounts of 20 to 70 wt. %, or from 30 to 50 wt. %, based on total weight of the coating composition.

In accordance with the present disclosure, to ensure light stability the coating compositions may be free of dyes. Other coating compositions may comprise dyes in amounts of up to 5 wt. %, or from 0.001 to 2 wt. %, based on total weight of the coating composition.

The coating composition in accordance with the present disclosure may include an effect pigment chosen from the group of metallic flake pigments, mica-containing pigments, glass-containing pigments, and combinations thereof.

The coating composition in accordance with the present disclosure may include a functional pigment, such as, for example, a radar reflective pigment, LiDAR reflective pigment, corrosion inhibiting pigment, and combinations thereof. Suitable radar reflective or LiDAR reflective pigments may include, for example, nickel manganese ferrite blacks (Pigment Black 30), iron chromite brown-blacks and commercially available infrared reflective pigments. The LiDAR reflective pigment may be referred to as an infrared reflective pigment. The coating compositions may include LiDAR reflective pigment in an amount of from 0.1 wt. % to 5 wt. % based on a total weight of the coating composition.

The LiDAR reflective pigment can include a semiconductor and/or a dielectric (“SCD”) in which a metal is dispersed. The medium (e.g., SCD) in which the metal is dispersed may also be referred to herein as the matrix. The metal and matrix can form a non-homogenous mixture that can be used to form the pigment. The metal can be dispersed uniformly or non-uniformly throughout the matrix. The semiconductor of the LiDAR reflective pigment can include, as nonlimiting examples, silicon, germanium, silicon carbide, boron nitride, aluminum nitride, gallium nitride, silicon nitride, gallium arsenide, indium phosphide, indium nitride, indium arsenide, indium antimonide, zinc oxide, zinc sulfide, zinc telluride, tin sulfide, bismuth sulfide, nickel oxide, boron phosphide, titanium dioxide, barium titanate, iron oxide, doped version thereof (i.e., an addition of a dopant, such as, for example, boron, aluminum, gallium, indium, phosphorous, arsenic, antimony, germanium, nitrogen, at a weight percentage of 0.01% or less based on the weight of the LiDAR reflective pigment), alloyed versions of thereof, other semiconductors, or combinations thereof. As a nonlimiting example, the LiDAR reflective pigment can comprise silicon. The dielectric of the LiDAR reflective pigment can comprise solid insulator materials (e.g., silicon dioxide), ceramics (e.g., aluminum oxide, yttrium oxide, yttria alumina garnet (YAG), neodymium-doped YAG (Nd:YAG)), glass (e.g., borosilicate glass, soda lime silicate glass, phosphate glass), organic materials, doped versions thereof, other dielectrics, or combinations thereof. The organic material can comprise, for example, acrylics, alkyds, chlorinated polyether, diallyl phthalate, epoxies, epoxy-polyamid, phenolics, polyamide, polyimides, polyesters (e.g., PET), polyethylene, polymethyl methacrylate, polystyrene, polyurethanes, polyvinyl butyral, polyvinyl chloride (PVC), copolymer of PVC and vinyl, acetate, polyvinyl formal, polyvinylidene fluoride, polyxylylenes, silicones, nylons and co-polymers of nylons, polyamide-polymide, polyalkene, polytetrafluoroethylene, other polymers, or combinations thereof. If the dielectric comprises organic materials, the organic materials are selected such that the pigment formed therefrom is resistant to melting and/or resistant to changes in dimension or physical properties upon incorporation into a coating, film, and/or article formulation. The metal in the LiDAR reflective pigment can comprise, for example, aluminum, silver, copper, indium, tin, nickel, titanium, gold, iron, alloys thereof, or combinations thereof. The metal can be in particulate form and can have an average particle size in a range of 0.5 nm to 100 nm, such as, for example, 1 nm to 10 nm as measured by a transmission electron microscope (TEM) at 100 kV. The metal can be in particulate form and can have an average particle size less than or equal to 20 nm as measured by TEM.

The coating composition in accordance with the present disclosure may comprise a corrosion inhibiting pigment, such as calcium strontium zinc phosphosilicate, zinc strontium phosphosilicate, calcium barium phosphosilicate, calcium strontium zinc phosphosilicate, and combinations thereof. The coating composition may include the corrosion inhibiting pigment in an amount of from 3 wt. % to 12 wt. % based on a total weight of the coating composition.

In accordance with the coating composition of the present disclosure may contain a variety of conventional additives including, but are not limited to, catalysts, including phosphonic acids, dispersants, surfactants, flow control agents, antioxidants, UV stabilizers and absorbers, surfactants, wetting agents, leveling agents, antifoaming or anti-gassing agents, anti-cratering agents, or combinations thereof.

Generally, both ionic and non-ionic surfactants are used together and the amount of surfactant ranges from 1 to 10 wt. %, or from 2 to 4 wt. %, based on the total solids. A nonlimiting example of a suitable surfactant for the preparation of and use in aminoplast curing dispersions is the dimethylethanolamine salt of dodecylbenzenesulfonic acid.

The solids content of the coating compositions of the present disclosure may range from 10 to 80 wt. %, or from 12 to 75 wt. %, or from 12 to 60 wt. %, or from 12 to 35 wt. %, or from 15 to 35 wt. %, based on the total weight of the coating compositions. The coating compositions of the present disclosure may have a solids content ranging up to 25 wt. % or, alternatively up to 35%, or, alternatively up to 60 wt. %, or, alternatively up to 75 wt. % alternatively, up to 80 wt. %. The coating compositions of the present disclosure may have a solids content ranging 10 wt. % or greater, or, alternatively, 12 wt. %, or greater, or, alternatively, 15 wt. %, or greater, or, alternatively 20 wt. % or greater, based on the total weight of the coating compositions.

The coating compositions of the present disclosure find use generally as basecoat, colorcoat or monocoat coating compositions, and in topcoat or clearcoat coating compositions to form a single layer coating or a multi-layer coating. The coating compositions of the present disclosure may also find use as primer or anti-corrosion coating compositions. Suitable topcoat coating compositions should be compatible with basecoat compositions and can be chemically different or contain different relative amounts of ingredients from a pigmented basecoat coating composition. Suitable aqueous topcoat and clearcoat coating compositions may comprise at least one thermosettable film-forming polymer or resin having one or more crosslinking-functional groups and, further may comprise at least one crosslinking material and can be the same as a pigmented basecoat coating composition but without the pigments.

In accordance with the coating compositions of the present disclosure, monocoat coating compositions may comprise a pigmented basecoat formulation having a film-forming polymer or resin with one or more crosslinking-functional groups as well as a crosslinking material. Further, topcoat and protective clearcoat coating compositions of the present disclosure may comprise the at least one film-forming polymer or resin having one or more crosslinking-functional groups and, further may comprise at least one crosslinking material and can be the same as a thermosetting pigmented basecoat coating composition but without the pigments.

In accordance with the methods of applying a coating composition to a substrate using a high transfer efficiency applicator, multi-layer coatings can include applying at least two coating compositions wherein applying one of the coating compositions comprises using a high transfer efficiency applicator to form one or more coating layers, or to form precisely applied coating layers. The precisely applied coating layers of the present disclosure may be any one or more or a primer or anti-corrosion coating layer, a basecoat coating layer, a monocoat coating layer, a protective clearcoat coating layer, a topcoat coating layer or any combination of these.

In methods of making the precisely applied coating layers of the present disclosure, the precisely applied coating layer may be any primer or anti-corrosion coating composition applied to any of a substrate or another cured or uncured primer or anti-corrosion coating layer.

In methods of making the precisely applied coating layers of the present disclosure, the precisely applied coating layer may be a basecoat coating composition, applied to any of substrate, or any of a cured or uncured primer or anticorrosion coating layer, monocoat coating layer, protective clearcoat coating layer, topcoat coating layer or another basecoat coating layer.

In methods of making the precisely applied coating layers of the present disclosure, the precisely applied coating layer may be a monocoat coating layer, applied to any of a substrate, or any of a cured or uncured primer coating layer, anticorrosion coating layer, protective clear coating layer, or basecoat coating layer.

In methods of making the precisely applied coating layers of the present disclosure, the precisely applied coating layer may be a clearcoat coating layer, applied to any of a substrate, or any of a cured or uncured primer or anticorrosion coating layer, monocoat coating layer, basecoat coating layer, or another protective clear coating layer.

The methods of forming a basecoat coating layer may comprise applying the same or different pigmented basecoat coating composition with a high transfer efficiency applicator to form one or more coating layers on a substrate, or after a substrate is coated with a primer or anti corrosion layer, or, after, optionally, forming a sealer on top of the primer for protection and adhesion.

The methods of the present disclosure can comprise: forming a first precisely applied basecoat layer over at least a portion of a substrate by depositing a first basecoat composition onto at least a portion of the substrate using a high transfer efficiency applicator having either a nozzle or a valve containing a nozzle orifice; and forming a second precisely applied basecoat layer over at least a portion of the first basecoat layer by depositing a second basecoat composition directly onto at least a portion of the first basecoat layer using a high transfer efficiency applicator having either a nozzle or a valve containing a nozzle orifice before or after the first basecoat composition is dehydrated and/or cured.

The methods may subsequently comprise forming a clearcoat layer by applying a clearcoat composition over a basecoat layer using a high transfer efficiency applicator for further protection and visual appearance. The methods may further comprise forming additional coating layers, for example, the method may comprise forming a pretreatment layer by applying phosphate material an electrocoat layer on a metal substrate before applying a primer layer using a high transfer efficiency applicator.

In accordance with the methods of the present disclosure, forming a basecoat layer may comprise applying pigmented basecoat coating composition to form a layer and then dehydrating the layer by heating to a temperature or by letting the layer a flash at ambient conditions for a time sufficient to drive off or allow solvent, for example, water, to evaporate from the coating layer. Suitable dehydration conditions depend on the basecoat composition employed and on the ambient humidity. Generally, heating dehydration times range from 1 to 5 minutes at a temperature of from 20° C. to 121° C. (80° F. to 250° F.), or from ambient temperatures to 100° C., or, from ambient temperatures to 90° C., or, from 40° C. to 80° C., or, from 50° C. to 80° C. and ambient dehydrating times range from 1 to 20 minutes.

In accordance with the present disclosure, the methods may comprise applying the coating composition using one or more than one high transfer efficiency applicators, with each configured to apply a different coating composition (e.g., different colors, solid or effect pigments, basecoat or clearcoat). Each high transfer efficiency applicator may comprise a nozzle or valve containing a nozzle orifice that expels coating compositions as droplets or jets. Each nozzle orifice exerts yield stress on the droplets or jets as they are expelled therefrom. Such devices may be, for example, a printhead containing one or more nozzles, or an applicator containing one or more nozzles or valves, such as a valve jet applicator. Each nozzle or valve containing device may be actuated via a piezo-electric, thermal, acoustic, or ultrasonic trigger or input, such as an ultrasonic spray applicator employing ultrasonic energy to an ultrasonic nozzle. Any suitable high transfer efficiency applicator or device for applying a coating composition may be configured to use in a continuous feed method, drop-on-demand method, or, selectively, both methods. Further, any suitable applicator device can be configured to apply a coating composition to a specific substrate, in a specific pattern, or both.

In accordance with the present disclosure, the high transfer efficiency applicator can comprise any number of nozzles or valves which can be arranged to form a nozzle or valve assembly configured to apply a coating composition to a specific substrate, in a specific pattern, or both. Likewise, two or more separate high transfer efficiency applicators can be arranged to form a single assembly. Each nozzle or valve may be actuated independent of the other nozzles or valves to apply the coating composition to a portion of or all of a substrate. Thus, in accordance with the methods of the present disclosure, the high transfer efficiency applicator may include a plurality of first nozzles, valves or jets each containing a nozzle orifice, wherein the high transfer efficiency applicator can be configured to expel a first coating composition independently through each of the nozzle orifice independently of one another. In accordance with the present disclosure, the nozzles or valves of a high transfer efficiency applicator or set of multiple high transfer efficiency applicators in an assembly thereof, may have any configuration known in the art, such as linear, concave relative to the substrate, convex relative to the substrate, circular, or gaussian. Configuring the nozzles, valves, or jets relative to the substrate can facilitate cooperation of the high transfer efficiency applicator to substrates having irregular configurations, such as, for example, vehicles including mirrors, trim panels, contours, or spoilers.

In accordance with the methods of the present disclosure, the one or more nozzles or valves of the high transfer efficiency applicator contain a nozzle orifice that may have a nozzle diameter of from 20 to 400 microns, such as from 30 to 340 microns. The droplets or jets expelled from the nozzle or valve each have a diameter of from 20 to 400 μm, or for example, from 30 to 340 μm.

In accordance with the present disclosure, suitable substrates may comprise those known in the art, such as a vehicle, including an automobile, or aircraft. The substrates may include a metal-containing material, a plastic-containing material, or a combination thereof, such as a non-porous substrate. Various substrates may include two or more discrete portions of different materials. For example, vehicles can include metal-containing body portions and plastic-containing trim portions. Due to the bake temperature limitations of plastics relative to metals, the metal-containing body portions and the plastic-containing trim portions may be conventionally coated in separate facilities thereby increasing the likelihood for mismatched coated parts. Alternatively, where cure and handling conditions permit, the metal-containing substrate may be coupled to the plastic-containing substrate.

For substrates susceptible to damage from stones and other debris on the roadway during operation, such as the leading edge of a vehicle, the methods of the present disclosure comprise applying an anti-chip coating composition including elastomeric polymers, such as internally crosslinked (co)polymers of butyl acrylate having a glass transition temperature (Tg) of 0° C. or below may to the substrate using the high transfer efficiency applicator without the need for masking the substrate.

The present disclosure further provides a system for applying a coating composition to a substrate using a high transfer efficiency applicator and that includes the high transfer efficiency applicator coupled to an automated or robotic application device which moves the high transfer efficiency applicator along a path set according to application instructions. The system further includes a storage device for storing application instructions for performing a matching protocol, and still further includes one or more data processors configured to execute the instructions to: receive via one or more data processors, target image data of a target coating, the target image data generated by an electronic imaging device; and apply the target image data to a matching protocol to generate application instructions.

### EXAMPLES

The following examples are used to illustrate the present disclosure without limiting it to those examples. Unless otherwise indicated, all temperatures were ambient temperatures (21-23° C.), all pressures were 1 atmosphere and relative humidity was 30%. Notwithstanding that the numerical ranges and parameters setting forth the broad scope of the disclosure are approximations, numerical values set forth in the specific examples are reported as precisely as possible. Any numerical value inherently contains certain errors necessarily resulting from the standard variation found in their respective testing measurements. The materials used in the Examples, below, are set forth in Table 1, below.

TABLE 1
Coating Compositions

| | | | | |
|---|---|---|---|---|
| EXAMPLE | 1 | 2 | 3 | *4 |

Aqueous phase ingredients

| | | | | |
|---|---|---|---|---|
| Demineralized water | 5.63 | 4.51 | 5.91 | 7.17 |
| Latex A ¹ | 5.10 | 10.30 | 5.64 | 5.22 |
| Latex B ² | 11.90 | 13.02 | 13.09 | 12.18 |
| Latex C ³ | 15.75 | 0.00 | 17.39 | 16.11 |
| Latex D ¹³ | 0.00 | 4.72 | 0.00 | 0.00 |
| Polyester A ⁴ | 27.44 | 28.83 | 18.33 | 28.07 |
| Polyester B ¹⁴ | | 2.55 | | 0.00 |
| Surfactant⁵ | 0.06 | 0.06 | 0.70 | 0.06 |
| Defoamer⁶ | 0.54 | 0.51 | 0.56 | 0.55 |
| Laponite solution¹⁵ | | 0.37 | | |
| Surfynol 104E¹⁶ | | 0.43 | | |
| Melamine A ⁷ | 9.31 | 9.20 | 10.28 | 9.53 |
| Black tint ⁸ | 19.27 | 22.09 | 24.08 | 19.72 |

Organic phase ingredients

| | | | | |
|---|---|---|---|---|
| Odorless mineral spirits ⁹ | 0.36 | 0.34 | 0.38 | 0.00 |
| Propylene glycol n-butyl ether ¹⁰ | 2.05 | 1.93 | 2.15 | 0.00 |
| n-butanol | 0.51 | 0.34 | 0.54 | 0.00 |
| Polypropylene glycol¹¹ | 1.40 | 0 | 0.87 | 0.69 |
| Defoamer ¹² | 0.69 | 0.65 | 0.72 | 0.70 |

¹ Core/shell urethane and hydroxyl functional acrylic latex polymer microparticles as disclosed in US 2015/0210883 A1 to Swarup et al., Example G part 1 and part 2. The volume average latex particle size was 130 nm; the solids content was 38.2 wt. %.
² Hydroxyl functional core/shell acrylic latex as disclosed in US 2015/0210883 A1 to Swarup et al., Example A. The volume average latex particle size was 140 nm; the solids content was 25.0 wt. %.
³ Single stage gradual addition polymerized emulsion polymer of with 8.8 parts of 50 wt. % aq. acrylamide, 63 parts of n-butyl methacrylate, 25.6 parts of 1,6 hexanediol diacrylate, 1.7 parts methyl methacrylate, 0.9 parts n-butyl acrylate with a solids content of 31.0% in water. The volume average latex particle size was 160 nm.
⁴ Waterborne hydroxyl functional polyester as disclosed in Example 9 of U.S. Pat. No. 6,762,240 to Swarup. et al.; the solids content was 20.0 wt. %.
⁵BYK ™ 348 silicone surfactant (Byk Chemie, Wallingford, CT).
⁶BYK ™ 032 P Emulsion of paraffin-containing mineral oils (Byk Chemie, Wallingford, CT).
⁷ Methylated melamine curing agent RESIMENE ™ HM-2608 resin (Prefere Resins Holding GmbH, Erkner, DE).
⁸ 36Black tint paste consisting of 6% carbon black (MONARCH ™ 1300, Cabot Corp, Boston, MA) dispersed in 17% acrylic polymer blend and having a solids content of 24 wt. %.
⁹ Shell Chemical Co. (Deer Park, TX).
¹⁰ DOWANOL ™ PnB (The Dow Chemical Co., Midland, MI).
¹¹ALCUPOL ™ D1011 polyol (Repsol Quimica S.A., Madrid, ES) a viscous liquid, OH number 110 mg KOH/g.
¹² BYKETOL ™ WS defoamer (Byk Chemie, Wallingford, CT).
¹³ Polyurethane-acrylic aqueous dispersion made of 9.73 wt % adipic acid, 11.30 wt % isophthalic acid, 2.15 wt % maleic anhydride, 21.66 wt % 1,6-hexanediol, 5.95 wt % dimethylolpropionic acid, 1.0 wt % butanediol, 16.07 wt % isophorone diisocyanate, 26.65 wt % butyl acrylate, 2.74 wt % hydroxypropyl methacrylate and 2.74 wt % ethylene glycol dimethacrylate, with a solids content 45 wt % in deionized water. The volume average particle size was 130 nm.
¹⁴ Hydroxy functional polyester as disclosed in U.S. Pat. No. 6,291,564 to Faler et al., Example 1; the solids content was 80.3 wt. %..
¹⁵A 2 wt. % aqueous solution of LAPONITE ™ RD layered silicate (Southern Clay Products, Gonzales, TX).
¹⁶Nonionic Surfactant (Air Products and Chemicals, Allentown, PA).
*Denotes Comparative Example.

The aqueous phase compositions in Table 1, above, were mixed under stirring. The organic phase ingredients were then mixed under stirring for 15 minutes prior to being added into the aqueous phase mixture. After mixing the aqueous and organic phase ingredients, the pH was adjusted to 8.5 using 50% dimethylethanolamine.

Test Methods: Viscosity and Yield Stress and Min d(log 10(visc)/stress): The yield stress of the coating composition formulations in Table, 1, above, was determined by measuring viscosity as a function of shear stress. Viscosity was measured with an Anton-Paar MCR301 (Anton Paar GmbH, Graz, AT) rheometer using a 50-millimeter parallel plate-plate fixture with temperature-control. The plate-plate distance was kept at a fixed distance of 0.2 mm and the temperature was a constant 25°. The viscosity of coatings was measured over a stress range from 50 mPa to at least 500000 mPa with a point spacing of 7 points per decade and the most relevant measures of viscosity are reported in Table 2, below. The yield stress was indicated by a sharp decrease in the viscosity as shear stress increased. The yield stress recorded was the shear stress at which the rate of decrease in viscosity was highest. The highest decrease in viscosity was calculated by determining the stress at which the first derivative of the Log₁₀ of the viscosity versus shear stress Min d(log 10(visc)/stress) reaches a minimum. One trial was completed for each formulation and the results are reported in Table 3, below.

TABLE 2
Viscosity of Shear Thinning Compositions
as a Function of Shear Stress

| | Example | | | |
|---|---|---|---|---|
| Test Method | 1 | 2 | 3 | 4* |
| A: Viscosity (mPa*s) @ | 46306 | 57799 | 41030 | 1542.8 |
| Shear Stress of 1 Pa | | | | |
| B: Viscosity (mPa*s) @ | 348.43 | 689.95 | 732.82 | 340.62 |
| Shear Stress of 10 Pa | | | | |
| Viscosity Profile (ratio | 132.9:1 | 83.8:1 | 56.0:1 | 4.5:1 |
| A/B) | | | | |

*Denotes Comparative Example.

TABLE 3
Yield Stress and Min d(log10(visc)/stress) of coating compositions

| | Yield Stress | Min d(log10(visc)/stress) |
|---|---|---|
| Example | (mPa) | mPa*s/mPa) |
| 1 | 3094.05 | −0.47281 |
| 2 | 3094.05 | −0.40472 |
| 3 | 4299.2 | −0.3513 |
| 4* | 5973.75 | −0.10548 |

*Denotes Comparative Example.

As shown in Table 2, above, the viscosity profile of the compositions according to this disclosure are far higher than that of the Comparative Example 4, which fails to include the swelling solvent and/or rheology modifier of the present disclosure. As shown in Table 3, above, the swelling solvent propylene glycol n-butyl ether in the coating compositions of Examples 1 to 3 and the rheology modifier solution in Example 2 provided a yield stress and the highest decrease in viscosity at an acceptably low level of shear stress. In contrast to the Examples according to this disclosure, the lack of a swelling solvent or rheology modifier in the coating composition of Comparative Example 4 led to a higher shear stress level before yield stress and thus more difficulty in shear thinning that composition. The composition of Comparative Example 4 fails to exhibit the needed shear thinning to enable effective and precise application of the coating compositions using a high transfer efficiency applicator, such as when applying a coating to only a portion of a substrate and/or a substrate.

Whereas the particulars of the present disclosure have been described above for purposes of illustration, it will be evident to those skilled in the art that numerous variations of the details of the present disclosure may be made without departing from the invention as defined in the appended claims.

1. A method of forming a coating layer on at least a portion of a substrate comprising:
applying an aqueous coating composition to a substrate using a high transfer efficiency applicator;
wherein the aqueous coating composition comprises (i) a film-forming polymer or resin, (ii) a polyurethane dispersion; (iii) crosslinked polymer microparticles; (iv) a polymer comprising one or more reactive functional groups; or (v) combinations thereof,
wherein, the aqueous coating composition has a viscosity ranging from 7 to 100 Pa*s at a shear stress of 1 Pa when measured using an Anton-Paar MCR301 rheometer equipped with a 50-millimeter parallel plate-plate fixture at 25° C. and a pressure of 101.3 kPa (1 atm) and keeping a plate-plate distance fixed at 0.2 mm.

2. The method of claim 1, wherein the aqueous coating composition comprises an aqueous carrier, and/or a rheology modifier and/or a swelling solvent that will swell the film-forming polymer or resin.

3. (canceled)

4. (canceled)

5. The method of claim 1, wherein the high transfer efficiency applicator comprises a nozzle orifice that expels the aqueous coating composition as a droplet or jet and that exerts a yield stress on the droplets or jets as they are expelled from the nozzle orifice.

6. The method of claim 1, wherein the aqueous coating composition has a viscosity ranging from 0.03 to 1 Pa*s, such as 0.1 to 1 Pa*s at a shear stress of 10 Pa when measured as a function of shear stress over a stress range from 0.05 Pa to 500 Pa with a point spacing of 7 points per decade and/or a rheology profile defined as the ratio of the viscosity at a shear stress of 1 Pa to the viscosity at a shear stress of 10 Pa of from 25:1 to 350:1 at 25° C. and a pressure of 101.3 kPa (1 atm), using an Anton-Paar MCR301 rheometer equipped with a 50 millimeter parallel plate-plate fixture with temperature-control and keeping a plate-plate distance fixed at 0.2 mm.

7. (canceled)

8. The method of claim 1, wherein the aqueous coating composition exhibits a yield stress of from 1 to 10 Pa and exhibits a minimum first derivative of the Log₁₀ of the viscosity versus shear stress ranging from −0.1 to −5.0 mPa*s/mPa and wherein the yield stress of the coating composition is less than the yield stress exerted on the droplet or jet of the coating composition as it is expelled from the nozzle orifice.

9. The method of claim 1, wherein the film-forming polymer or resin has at least one crosslinking-functional group and the coating composition further comprises a crosslinking material having at least one functional group reactive with the crosslinking-functional group, and/or wherein the swelling solvent comprises a solvent selected from the group consisting of alkyl ethers, glycol ethers, hydrophobic group containing alcohols, hydrophobic group containing ketones, alkyl esters, alkyl phosphates, and mixtures thereof, and/or wherein the rheology modifier comprises an inorganic thixotropic agent, an acrylic alkali swellable emulsion (ASE), an associative thickener, cellulosic thickener, polyvinyl alcohol, polyvinyl pyrrolidone, polyvinyl methylether, polyethylene oxide, polyacrylamide, ethylene vinyl acetate, polyamide, polyacrylic acid, or mixtures thereof.

10-19. (canceled)

20. The method of claim 1, wherein the high transfer efficiency applicator comprises a valve jet applicator having one or more nozzles, each of which expels the aqueous coating composition in the form of a coherent coating composition jet, wherein each nozzle expels the aqueous coating composition to form a jet having the form of a line segment, a planar jet or lamina, a hollow cylindrical jet, or wherein more than one nozzle cooperatively expels the coating composition to form a liquid sheet.

21. (canceled)

22. The method as claimed in claim 1, wherein the aqueous coating composition is a pigmented basecoat coating composition.

23. The method as claimed in claim 1, wherein the method comprises applying a primer layer on the substrate prior to applying the aqueous coating composition.

24. The method of claim 1, wherein the method further comprises applying, using a high transfer efficiency applicator, a clearcoat coating composition over at least a portion of the aqueous coating composition that has been applied to the substrate.

25-29. (canceled)

30. A substrate coated by the method as claimed in claim 1.

31. The substrate as claimed in claim 30, wherein the substrate is a vehicle or a portion thereof.

32. An aqueous coating composition comprising:
(i) a film-forming polymer or resin,
(ii) a polyurethane dispersion;
(iii) crosslinked polymer microparticles;
(iv) a polymer comprising one or more reactive functional groups; or
(iv) combinations thereof,
wherein, the aqueous coating composition has a viscosity ranging from 7 to 100 Pa*s, such as 10 to 100 Pa*s at a shear stress of 1 Pa when measured using an Anton-Paar MCR301 rheometer equipped with a 50-millimeter parallel plate-plate fixture at 25° C. and a pressure of 101.3 kPa (1 atm) and keeping a plate-plate distance fixed at 0.2 mm.

33. The aqueous coating composition according to claim 32 comprising an aqueous carrier, and/or a rheology modifier, and/or a swelling solvent that will swell the film-forming polymer or resin.

34-35. (canceled)

36. The aqueous coating composition according to claim 32, wherein the aqueous coating composition has a viscosity ranging from 0.03 to 1 Pa*s, such as 0.1 to 1 Pa*s at a shear stress of 10 Pa when measured as a function of shear stress over a stress range from 0.05 Pa to 500 Pa with a point spacing of 7 points per decade, and/or a rheology profile defined as the ratio of the viscosity at a shear stress of 1 Pa to the viscosity at a shear stress of 10 Pa of from 25:1 to 350:1, and/or exhibits a yield stress of from 1 to 10 Pa and exhibits a minimum first derivative of the Log₁₀ of the viscosity versus shear stress ranging from −0.1 to −5.0 mPa*s/mPa at 25° C. and a pressure of 101.3 kPa (1 atm), using an Anton-Paar MCR301 rheometer equipped with a 50 millimeter parallel plate-plate fixture with temperature-control and keeping a plate-plate distance fixed at 0.2 mm.

37-38. (canceled)

39. The aqueous coating composition according to claim 32, wherein the film-forming polymer or resin has at least one crosslinking-functional group and the coating composition further comprises a crosslinking material having at least one functional group reactive with the crosslinking-functional group, and/or wherein the swelling solvent comprises a solvent selected from alkyl ethers, glycol ethers, hydrophobic group containing alcohols, hydrophobic group containing ketones, alkyl esters, alkyl phosphates, and mixtures thereof, and/or wherein the rheology modifier comprises an inorganic thixotropic agent, an acrylic alkali swellable emulsion (ASE), an associative thickener, cellulosic thickener, polyvinyl alcohol, polyvinyl pyrrolidone, polyvinyl methylether, polyethylene oxide, polyacrylamide, ethylene vinyl acetate, polyamide, polyacrylic acid, or mixtures thereof.

40-46. (canceled)

47. The aqueous coating composition according to claim 32, wherein the rheology modifier comprises a combination of an inorganic thixotropic agent and an ASE.

48. The aqueous coating composition according to claim 32, wherein the aqueous coating composition comprises one or more swelling solvents, the film-forming polymer comprises iii) an acrylic or vinyl addition polymer having at least one crosslinking-functional group as the one or more reactive functional groups, and the coating composition further comprises both a crosslinking material of a melamine resin, and a hydrophobically modified ethylene oxide urethane block copolymer (HEUR) associative thickener.

49. (canceled)

50. The aqueous coating composition according to claim 32 comprising a colorant.

51. (canceled)

52. The aqueous coating composition according to claim 32, comprising a pigment is selected from titanium dioxide, zinc oxide, iron oxide, carbon black, mono azo red, red iron oxide, quinacridone maroon, transparent red oxide, cobalt blue, iron blue, iron oxide yellow, chrome titanate, titanium yellow, nickel titanate yellow, transparent yellow oxide, lead chromate yellow, bismuth vanadium yellow, pre darkened chrome yellow, transparent red oxide chip, iron oxide red, molybdate orange, molybdate orange red, LiDAR reflective pigments and combinations thereof.
